(19) United States
(12) Patent Application Publication
(10) Pub. No.: US 2026/0370887 A1
(43) Pub. Date: Nov. 19, 2026

(54) METHOD AND APPARATUS FOR COEFFICIENT CODING IN VIDEO CODING

(71) Applicant: GUANGDONG OPPO MOBILE TELECOMMUNICATIONS CORP., LTD., Dongguan (CN)

(72) Inventors: Jonathan GAN, Dongguan (CN); Yue YU, Dongguan (CN)

(73) Assignee: GUANGDONG OPPO MOBILE TELECOMMUNICATIONS CORP., LTD., Dongguan (CN)

(21) Appl. No.: 19/737,970

(22) Filed: Jul. 10, 2026

Related U.S. Application Data
(63) Continuation of application No. PCT/CN2024/129790, filed on Nov. 4, 2024.
(60) Provisional application No. 63/620,137, filed on Jan. 11, 2024.

(51) Int. Cl. H04N 19/70; H04N 19/132; H04N 19/176; H04N 19/60

(52) U.S. Cl. CPC H04N 19/70; H04N 19/132; H04N 19/176; H04N 19/60

(57) ABSTRACT

According to one aspect of the present disclosure, a method of decoding by a decoder is provided. The method may include performing by a processor, at least one coding pass to decode a plurality of context coded syntax elements for coefficients of a residual block. The method may include performing, by the processor, at least one other coding pass to decode a plurality of bypass coded syntax elements for coefficients of the residual block. The method may include calculating, by the processor, coefficient values for coefficients of the residual block based on the plurality of context coded syntax elements and the plurality of bypass coded syntax elements.

### CROSS-REFERENCE TO RELATED APPLICATIONS

This application is a continuation of International Application No. PCT/CN2024/129790, filed on Nov. 4, 2024, which claims the benefit of priority to U.S. Provisional Application No. 63/620,137, entitled “COEFFICIENT CODING IN VIDEO CODING” and filed on Jan. 11, 2024, both of which are incorporated by reference herein in their entireties.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, enhanced video coding model (ECM), to name a few.

### SUMMARY

According to one aspect of the present disclosure, a method of decoding by a decoder is provided. The method may include performing by a processor, at least one coding pass to decode a plurality of context coded syntax elements for coefficients of a residual block. The method may include performing, by the processor, at least one other coding pass to decode a plurality of bypass coded syntax elements for coefficients of the residual block. The method may include calculating, by the processor, coefficient values for coefficients of the residual block based on the plurality of context coded syntax elements and the plurality of bypass coded syntax elements.

According to another aspect of the present disclosure, a decoder is provided. The decoder may include a processor and memory storing instructions. The memory storing instructions, which when executed by the processor, may cause the processor to perform at least one coding pass to decode a plurality of context coded syntax elements for coefficients of a residual block. The memory storing instructions, which when executed by the processor, may cause the processor to perform at least one other coding pass to decode a plurality of bypass coded syntax elements for coefficients of the residual block. The memory storing instructions, which when executed by the processor, may cause the processor to calculate coefficient values for coefficients of the residual block based on the plurality of context coded syntax elements and the plurality of bypass coded syntax elements.

According to a further aspect of the present disclosure, an apparatus for decoding is provided. The apparatus for decoding may include a processor and memory storing instructions. The memory storing instructions, which when executed by the processor, may cause the processor to perform at least one coding pass to decode a plurality of context coded syntax elements for coefficients of a residual block. The memory storing instructions, which when executed by the processor, may cause the processor to perform at least one other coding pass to decode a plurality of bypass coded syntax elements for coefficients of the residual block. The memory storing instructions, which when executed by the processor, may cause the processor to calculate coefficient values for coefficients of the residual block based on the plurality of context coded syntax elements and the plurality of bypass coded syntax elements.

According to another aspect of the present disclosure, a non-transitory computer-readable medium is provided. The non-transitory computer-readable medium may instructions, which when executed by a processor of a decoder, may cause the processor of the decoder to perform at least one coding pass to decode a plurality of context coded syntax elements for coefficients of a residual block. The instructions, which when executed by the processor of the decoder, may cause the processor of the decoder to perform at least one other coding pass to decode a plurality of bypass coded syntax elements for coefficients of the residual block. The instructions, which when executed by the processor of the decoder, may cause the processor of the decoder to calculate coefficient values for coefficients of the residual block based on the plurality of context coded syntax elements and the plurality of bypass coded syntax elements.

According to one aspect of the present disclosure, a method of encoding by a encoder is provided. The method may include performing by a processor, at least one coding pass to encode a plurality of context coded syntax elements for coefficients of a residual block. The method may include performing, by the processor, at least one other coding pass to encode a plurality of bypass coded syntax elements for coefficients of the residual block.

According to another aspect of the present disclosure, a encoder is provided. The encoder may include a processor and memory storing instructions. The memory storing instructions, which when executed by the processor, may cause the processor to perform at least one coding pass to encode a plurality of context coded syntax elements for coefficients of a residual block. The memory storing instructions, which when executed by the processor, may cause the processor to perform at least one other coding pass to encode a plurality of bypass coded syntax elements for coefficients of the residual block.

According to a further aspect of the present disclosure, an apparatus for encoding is provided. The apparatus for encoding may include a processor and memory storing instructions. The memory storing instructions, which when executed by the processor, may cause the processor to perform at least one coding pass to encode a plurality of context coded syntax elements for coefficients of a residual block. The memory storing instructions, which when executed by the processor, may cause the processor to perform at least one other coding pass to encode a plurality of bypass coded syntax elements for coefficients of the residual block.

According to another aspect of the present disclosure, a non-transitory computer-readable medium is provided. The non-transitory computer-readable medium may instructions, which when executed by a processor of a encoder, may cause the processor of the encoder to perform at least one coding pass to encode a plurality of context coded syntax elements for coefficients of a residual block. The instructions, which when executed by the processor of the encoder, may cause the processor of the encoder to perform at least one other coding pass to encode a plurality of bypass coded syntax elements for coefficients of the residual block.

According to still another aspect of the present disclosure, a non-transitory computer-readable medium storing a bitstream is provided. The bitstream may be generated according to one or more of the operations described herein.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary encoder in the encoding system in FIG. 1, according to some embodiments of the present disclosure.

FIG. 4 illustrates a detailed block diagram of an exemplary decoder in the decoding system in FIG. 2, according to some embodiments of the present disclosure.

FIG. 5 illustrates an exemplary picture divided into coding tree units (CTUs), according to some embodiments of the present disclosure.

FIG. 6 illustrates an exemplary CTU divided into coding units (CUs), according to some embodiments of the present disclosure.

FIG. 7 illustrates a diagram of a first RRC scan order, according to some embodiments of the present disclosure.

FIG. 8 illustrates a diagram of a second RRC scan order, according to some embodiments of the present disclosure.

FIG. 9 illustrates a diagram of a TSRC scan order, according to some embodiments of the present disclosure.

FIG. 10 illustrates an example bitstream order of coding context and bypass coded bins in an RRC process, according to some embodiments of the present disclosure.

FIG. 11 illustrates an example bitstream order of coding context and bypass coded bins in a TSRC process, according to some embodiments of the present disclosure.

FIG. 12 illustrates a first exemplary bitstream order of coding context and bypass coded bins in an RRC process, according to some embodiments of the present disclosure.

FIG. 13 illustrates a second exemplary bitstream order of coding context and bypass coded bins in an RRC process, according to some embodiments of the present disclosure.

FIG. 14 illustrates a first exemplary bitstream order of coding context and bypass coded bins in an TSRC process, according to some embodiments of the present disclosure.

FIG. 15 illustrates a second exemplary bitstream order of coding context and bypass coded bins in an RRC process, according to some embodiments of the present disclosure.

FIG. 16 illustrates a flowchart of a method of decoding, according to some embodiments of the present disclosure.

FIG. 17 illustrates a flowchart of a method of encoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

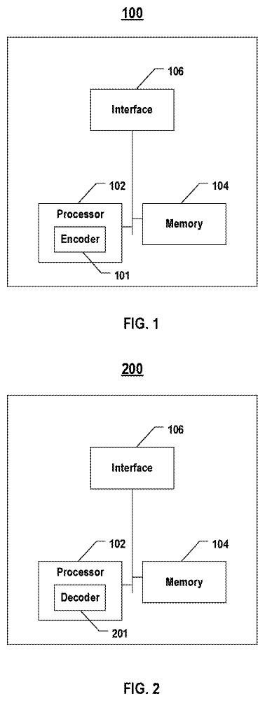

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a. secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one memory is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101. Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201. Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, e.g., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

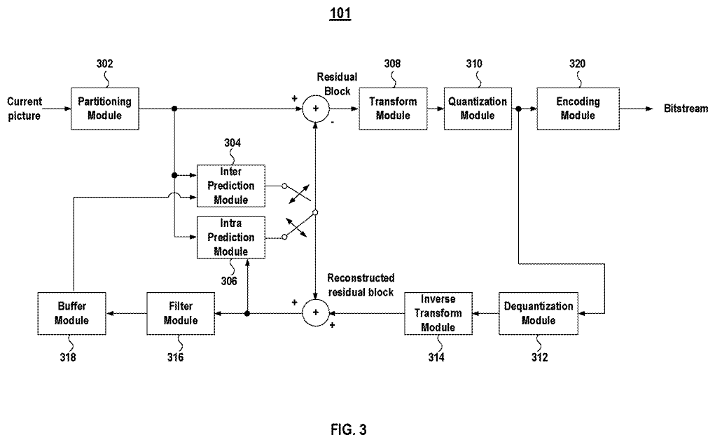

FIG. 3 illustrates a detailed block diagram of exemplary encoder 101 in encoding system 100 in FIG. 1, according to some embodiments of the present disclosure. As shown in FIG. 3, encoder 101 may include a partitioning module 302, an inter prediction module 304, an intra prediction module 306, a transform module 308, a quantization module 310, a dequantization module 312, an inverse transform module 314, a filter module 316, a buffer module 318, and an encoding module 320. It is understood that each of the elements shown in FIG. 3 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 101.

Partitioning module 302 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 302 may partition a picture into a combination of a plurality of coding units, prediction units, and transform units, and encode a picture by selecting a combination of a coding unit, a prediction unit, and a transform unit based on a predetermined criterion (e.g., a cost function).

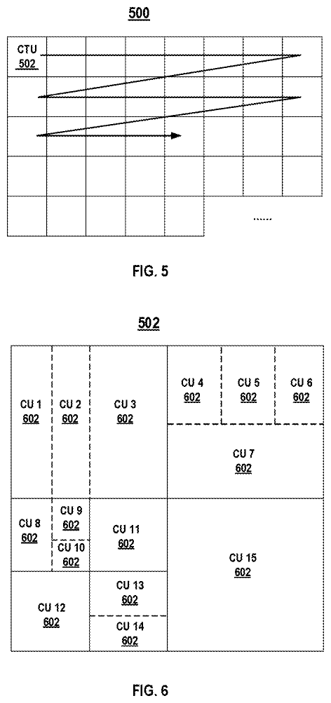

Similar to H.265/HEVC, H.266/VVC is a block-based hybrid spatial and temporal predictive coding scheme. As shown in FIG. 5, during encoding, an input picture 500 is first divided into square blocks referred to as coding tree units (CTUs)-CTUs 502, by partitioning module 302. For example, CTUs 502 can be blocks of 128×128 pixels. As shown in FIG. 6, each CTU 502 in input picture 500 can be partitioned by partitioning module 302 into one or more CUs 602, which can be used for prediction and transformation. Unlike H.265/HEVC, in H.266/VVC, CUs 602 can be rectangular or square, and can be coded without further partitioning into prediction units or transform units. For example, as shown in FIG. 6, the partition of CTU 502 into CUs 602 may include quadtree splitting (indicated in solid lines), binary tree splitting (indicated in dashed lines), and ternary splitting (indicated in dash-dotted lines). Each CU 602 can be as large as its root CTU or be subdivisions of root CTU 502 as small as 4×4 blocks, according to some embodiments.

Referring to FIG. 3, inter prediction module 304 may be configured to perform inter prediction on a prediction unit, and intra prediction module 306 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a coding unit, and prediction may be performed in a prediction unit. Residual coefficients in a residual block between the generated prediction block and the original block may be input into transform module 308. In addition, prediction mode information, motion vector information, and the like used for prediction may be encoded by encoding module 320 together with the residual coefficients or quantization levels into the bitstream. It is understood that in certain encoding modes, an original block may be encoded as it is without generating a prediction block through prediction module 304 or 306. It is also understood that in certain encoding modes, prediction, transform, and/or quantization may be skipped as well.

In some embodiments, inter prediction module 304 may predict a prediction unit based on information on at least one picture among pictures before or after the current picture, and in some cases, it may predict a prediction unit based on information on a partial area that has been encoded in the current picture. Inter prediction module 304 may include sub-modules, such as a reference picture interpolation module, a motion prediction module, and a motion compensation module (not shown). For example, the reference picture interpolation module may receive reference picture information from buffer module 318 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

Still referring to FIG. 3, in some embodiments, intra prediction module 306 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. Intra prediction may be performed on the prediction unit based on previously decoded pixels neighboring the prediction unit on the left, above-left, and above.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit are the same as the prediction unit in the neighborhood may be transmitted using predetermined flag information, and if the prediction modes of the current prediction unit and the prediction unit in the neighborhood are different from each other, prediction mode information of the current block may be encoded by extra flags information.

As shown in FIG. 3, a residual block including a prediction unit that has performed prediction based on the prediction unit generated by prediction module 304 or 306 and residual coefficient information (also referred to herein as the “residual”), which is a difference value of the prediction unit with the original block, may be generated. The generated residual block may be input into transform module 308. Additional details of residuals and transforms for video coding will now be provided.

In hybrid video coding systems, redundancy in the video signal is first exploited by applying inter or intra prediction tools for each CU. The difference between the original samples of a CU and the prediction block for that CU is commonly referred to as the residual. Even after prediction, the residual may still be highly spatially correlated. Although conditional entropy coding can capture some spatial dependency between adjacent samples, it is computationally impractical to form entropy coding statistical models that can fully exploit spatial correlation in the residual. In contrast, transform coding is a practical and effective method for spatially decorrelating the residual.

For example, transform module 308 may transform the residual using an integerized version of the two-dimensional discrete cosine transform (DCT), which may be applied separably in the horizontal and vertical directions. For an M×N block of residual samples (where M is the width of the block and N is the height of the block), transform module 308 may obtain transform coefficients by applying an M×M DCT to each row, resulting in intermediate transform coefficients, and then applying an N×N DCT to each column of intermediate transform coefficients.

For intra-coded CUs (also referred to herein as “intra CUs”), spatial neighboring reconstructed samples are used to predict the current block, and the intra prediction mode is signaled once for the entire CU. Each CU consists of one or more collocated coding blocks (CBs) corresponding to the color components of the video sequence. For example, consumer video typically takes the 4:2:0 chroma format, in which case each CU consists of a luma CB and two chroma CBs with one-quarter of the samples of the luma CB. Intra prediction and transform coding are performed at the prediction block (PB) and transform block (TB) levels, respectively. Each CB consists of a single TB, except in the cases of Intra Subpartition (ISP) mode and implicit splitting. For luma CBs, the maximum side length of a TB is 64, and the minimum side length is 4. In addition, luma TBs are further specified as W×H rectangular blocks of width W and height H, where W, H∈{4, 8, 16, 32, 64}. For chroma CBs, the maximum TB side length is 32, and chroma TBs are rectangular W×H blocks of width W and height H. Here, W, H∈{2, 4, 8, 16, 32}, but blocks of shapes 2×H and 4×2 are excluded in order to address memory architecture and throughput requirements.

To determine whether samples have already been reconstructed, we consider the partitioning structure of VVC. Referring to FIG. 5, each picture is divided into a tiling of square CTUs, which are processed in raster scan order. When an intra prediction method is performed on a current CU 602 in a current CTU 502, samples belonging to other CTUs preceding current CTU 502 in raster scan order are reconstructed and may be available for prediction. Samples belonging to CTUs following the current CTU 502 in raster scan order are not reconstructed and, therefore, are not available.

Each CTU 502 itself is partitioned into CUs by a hierarchical structure consisting of quadtree, binary tree, and ternary tree splits, with an example of such splits shown in FIG. 6. The scan order of CUs within a CTU 502 is determined by the partitioning structure. For a single level of partitioning split, the partitions are scanned in the following order: 1) left to right for the cases of horizontal binary tree split or horizontal ternary tree split, 2) top to bottom for the cases of vertical binary tree split or vertical ternary tree split, and 3) top-left, top-right, bottom-left, bottom-right for the case of quadtree split.

If a partition contains further hierarchical splits, then all CUs within that partition are scanned before continuing to the CUs in the next partition. FIG. 6 shows an example of partitioning of a CTU 502 into 15 CUs. Each CU 602 in FIG. 6 is numbered from 1 to 15 to indicate their scan order. When an intra prediction method is performed on a current CU in a current CTU, samples belonging to other CUs in the current CTU that precede the current CU in the current CTU's partitioning scan order are reconstructed and may be available for prediction. Samples belonging to the current CU, or CUs following the current CU in the current CTU's partitioning scan order are not reconstructed and, therefore, not available.

Samples belonging to a CTU preceding the current CTU in raster scan order are considered reconstructed by the definition above. However, they are not necessarily available for intra prediction. To be considered available for prediction, they must also belong to a logical unit that the current CU is permitted to use. Pictures may be divided into sub-picture partitions, each of which contains a whole number of CTUs.

Referring again to FIG. 3, transform module 308 can transform the video signals in the residual block from the pixel domain to a transform domain (e.g., a frequency domain depending on the transform method). It is understood that in some examples, transform module 308 may be skipped, and the video signals may not be transformed to the transform domain.

Quantization module 310 may be configured to quantize the coefficient of each position in the coding block to generate quantization levels of the positions. The current block may be the residual block. That is, quantization module 310 can perform a quantization process on each residual block. The residual block may include N×M positions (samples), each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a. inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 310. Which quantizer will be used for quantizing the current coefficient may depend on the information preceding the current coefficient in coding scan order. Such a quantization process is referred to as dependent quantization.

Referring to FIG. 3, encoding module 320 may be configured to encode the quantization level of each position in the coding block into the bitstream. In some embodiments, encoding module 320 may perform entropy encoding on the coding block. Entropy encoding may use various binarization methods, such as Golomb-Rice binarization, to convert each quantization level into a respective binary representation, such as binary bins. Then, the binary representation can be further compressed using entropy encoding algorithms. The compressed data may be added to the bitstream. Besides the quantization levels, encoding module 320 may encode various other information, such as block type information of a coding unit, prediction mode information, partitioning unit information, prediction unit information, transmission unit information, motion vector information, reference frame information, block interpolation information, and filtering information input from, for example, prediction modules 304 and 306. In some embodiments, encoding module 320 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined Truncated Rice (TR) and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of context-adaptive binary arithmetic coding (CABAC) can support two operating modes: a context coding mode, in which the bins are coded with adaptive probability models, and a less complex bypass mode that uses a fixed probability of ½. The adaptive probability models are also called contexts, and the assignment of probability models to individual bins is referred to as context modeling.

As shown in FIG. 3, dequantization module 312 may be configured to dequantize the quantization levels by dequantization module 312, and inverse transform module 314 may be configured to inversely transform the coefficients transformed by transform module 308. The reconstructed residual block generated by dequantization module 312 and inverse transform module 314 may be combined with the prediction units predicted through prediction module 304 or 306 to generate a reconstructed block.

Filter module 316 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 318 may be configured to store the reconstructed block or picture calculated through filter module 316, and the reconstructed and stored block or picture may be provided to inter prediction module 304 when inter prediction is performed.

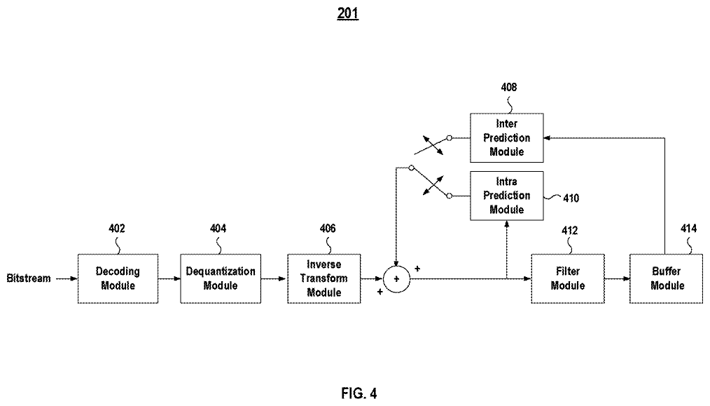

FIG. 4 illustrates a detailed block diagram of exemplary decoder 201 in decoding system 200 in FIG. 2, according to some embodiments of the present disclosure. As shown in FIG. 4, decoder 201 may include a decoding module 402, a dequantization module 404, an inverse transform module 406, an inter prediction module 408, an intra prediction module 410, a filter module 412, and a buffer module 414. It is understood that each of the elements shown in FIG. 4 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 201.

When a video bitstream is input from a video encoder (e.g., encoder 101), the input bitstream may be decoded by decoder 201 in a procedure opposite to that of the video encoder. Thus, some details of decoding that are described above with respect to encoding may be skipped for ease of description. Decoding module 402 may be configured to decode the bitstream to obtain various information encoded into the bitstream, such as the quantization level of each position in the coding block. In some embodiments, decoding module 402 may perform entropy decoding (decompressing) corresponding to the entropy encoding (compressing) performed by the encoder, such as, for example, context-adaptive variable-length coding (CAVLC), CABAC, syntax-based binary arithmetic coding (SBAC), PIPE coding, and the like to obtain the binary representation (e.g., binary bins). Decoding module 402 may further convert the binary representations to quantization levels using Golomb-Rice binarization, including, for example, EGk binarization and combined TR and limited EGk binarization. Besides the quantization levels of the positions in the transform units, decoding module 402 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 402 may perform rearrangement on the bitstream to reconstruct and rearrange the data from a 1D order into a 2D rearranged block through a method of inverse-scanning based on the coding scan order used by the encoder.

Dequantization module 404 may be configured to dequantize the quantization level of each position of the coding block (e.g., the 2D reconstructed block) to obtain the coefficient of each position. In some embodiments, dequantization module 404 may perform dependent dequantization based on quantization parameters provided by the encoder as well, including the information related to the quantizers used in dependent quantization, for example, the quantization step size used by each quantizer.

Inverse transform module 406 may be configured to perform inverse transformation, for example, inverse discrete cosine transform (DCT), inverse discrete sine transform (DST), and inverse Karhunen-Loeve transform (KLT), for DCT, DST, and KLT performed by the encoder, respectively, to transform the data from the transform domain (e.g., coefficients) back to the pixel domain (e.g., luma and/or chroma information). In some embodiments, inverse transform module 406 may selectively perform a transform operation (e.g., DCT, DST, KLT) according to a plurality of pieces of information such as a prediction method, a size of the current block, a prediction direction, and the like.

Inter prediction module 408 and intra prediction module 410 may be configured to generate a prediction block based on information related to the generation of a prediction block provided by decoding module 402 and information of a previously decoded block or picture provided by buffer module 414. Intra prediction may be performed on the prediction unit based on previously decoded pixels neighboring the prediction unit on the left, above-left, and above.

Video data is highly compressible because it is highly redundant in both the spatial and temporal dimensions. Theoretically, such redundancy can be compressed solely with an entropy coder (located at encoding module 320 and decoding module 402) modeling the statistical characteristics of the video data at a high enough order. However, the dimensionality of such a statistical model would be infeasibly high, making such an approach impractical to implement. For this reason, modern video coding standards typically use a block-based hybrid predictive paradigm, in which much of the redundancy of the video signal is exploited by block-based prediction. As used herein, the term “coding” refers to encoding or decoding.

In VVC, the prediction methods used are selected at a CU level, with one method selected for predicting the luma component and another method selected for predicting the chroma components. Each color component of a CU is referred to as a coding block (CB). In some cases, e.g., such as the intra sub-partition (ISP) tool, the CB may be further subdivided into multiple prediction blocks (PB), with a prediction generated for each PB. However, in most cases, the CB corresponds to a single PB of the same size. The difference between the original samples of the PB and the prediction is referred to as the residual, and ideally, the residual is minimized when the prediction is accurate.

For video data typically captured using a camera, the residual may benefit from applying a transform, e.g., such as a two-dimensional discrete cosine transform (DCT), before quantizing, and then the transform coefficients are coded. As with prediction methods, the choice of transform can be selected on a block-by-block basis, including selection of a “transform skip” mode. Each PB typically corresponds to a single transform block (TB) of the same size, which means that the transform (or transform skip) is applied directly to the residual of the PB. However, in some cases, a PB may be further subdivided into multiple TBs. For example, if the size of the PB is larger than the largest transform supported by the decoding module 402, then the PB may be divided into tiled TBs of size that can be transformed. For example, a 256×256 size PB would be divided into 4 TBs of 128×128 size when the decoding module 402 can only support up to 128-point DCT transforms.

Residual coding then refers to the process of coding the residual samples in each transform block (also referred to as a “residual block”) to the bitstream. In VVC, there are two alternative processes. For blocks where a transform is selected, the resulting transform coefficients are binarized and coded through a regular residual coding (RRC) process, which is performed by the encoding module 320 and the decoding module 402. For blocks where transform skip is selected, the residual coefficients may be coded by a process called the transform skip residual coding (TSRC) process, which is performed by the encoding module 320 and the decoding module 402. This latter process may be overridden (e.g., the RRC is forced even for transform skip blocks) if a slice-level TSRC disable flag is set.

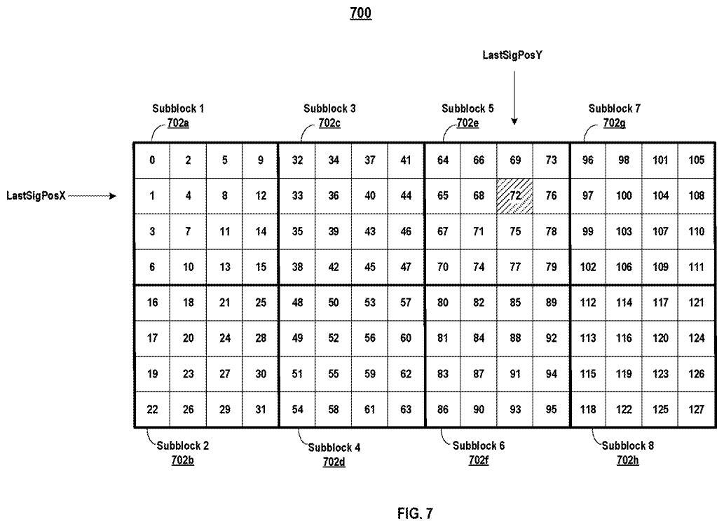

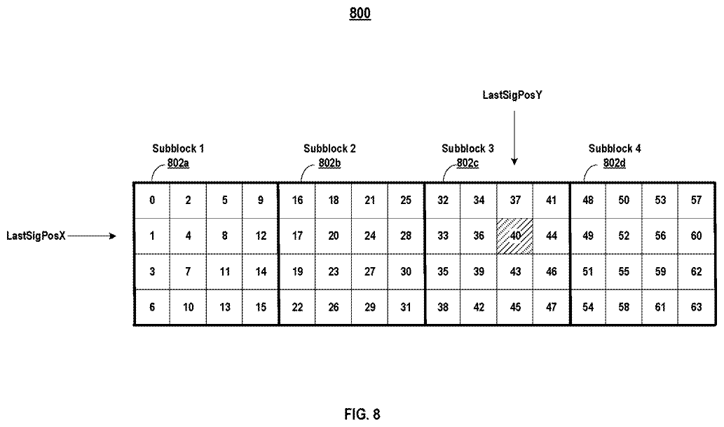

In RRC, the coding process is highly optimised for the purpose of coding transform coefficients. One purpose of applying a transform is to produce energy compaction—that is, the energy of the original residual is compacted into a relatively small number of transform coefficients. This implies that after quantisation, many transform coefficients should be zero in value. To efficiently code this, VVC employs a hierarchical subblock coding scheme. Transform coefficients are grouped into 4×4 subblocks (as shown in FIGS. 7 and 8), and for each subblock a subblock coded flag (sb_coded_flag) may be signaled or inferred. A subblock coded flag value of 1 indicates that at least one coefficient in the subblock is non-zero, while a value of 0 indicates that all the coefficients are zero.

As a transform should result in energy compaction, a natural question may be compaction in which coefficients. The application of a transform in VVC typically results in large-valued transform coefficients occurring in a localised (top-left) area of the block. For example, when the DCT is used, the transform coefficients correspond to spatial frequencies of the residual signal. By convention, the coefficients are ordered from low frequency to high frequency, with horizontal frequencies ordering left to right and vertical frequencies ordering top to bottom. That is, the low frequency coefficients both horizontally and vertically are located at the top-left of the block, while the high frequency coefficients both horizontally and vertically are located at the bottom-right of the block. It is known that “natural” (e.g., camera-captured) images have most of their energy concentrated in the low frequencies, and therefore, the coefficients corresponding to these frequencies, which reside in the top-left of the block while have the largest values. Other transforms used in VVC either are similar in behaviour due to also being frequency-based transforms such as the multi transform set (MTS), or are designed to concentrate large-valued coefficients in the same top-left area.

RRC exploits this localised property of transform coefficients in two ways. Firstly, a hierarchical reverse diagonal scan through the coefficients is defined, which begins at the highest spatial frequencies (the bottom-right of the block), and ends at the lowest spatial frequencies (the top-left of the block). This scan order approximately orders the coefficients from low to high magnitude. Entropy coding is performed along the direction of this scan order, which allows efficient adaptation to the changing statistics of the coefficients as they increase in magnitude gradually. Secondly, as it is expected many of the high frequency coefficients are quantized to zero, the position of the last significant coefficient (in the forward direction of the hierarchical diagonal scan) is signaled.

FIG. 7 illustrates a diagram of a first RRC scan order 700 for a 16×8 residual block, according to some embodiments of the present disclosure. The coefficient positions are each labeled with their order in the forward direction of the hierarchical diagonal scan, so that the top-left most position is labelled 0, and so on. The scan is hierarchical because whenever it enters a subblock (e.g., subblock 1 702a, subblock 2 702b, subblock 3 702c, subblock 4 702d, subblock 5 702e, subblock 6 702f, subblock 7 702g, or subblock 8 702h) it passes through all coefficients of that subblock before continuing to the next subblock. In this non-limiting example, the last significant position is identified at position 72 by signaling the horizontal component of the last significant position (LastSigPosX=10) and the vertical component of the last significant position (LastSigPosY=1). Then, the hierarchical reverse diagonal scan for this example begins at position 72, and proceeds backward through the numbered positions 71, 70, and so forth, ending at position 0.

FIG. 8 illustrates a diagram of a second RRC scan order 800 for a 16×4 residual block, according to some embodiments of the present disclosure. In this non-limiting example, the last significant position is in the same spatial location as in FIG. 7, e.g., that is, at LastSigPosX=10 and LastSigPosY=1. However, its position in the scan order is different because of the arrangement of the subblocks (e.g., subblock 1 802a, subblock 2 802b, subblock 3 802c, and subblock 4 802d). The hierarchical reverse diagonal scan for this example begins at position 40, and proceeds backward through the numbered positions 39, 38, and so forth, ending at position 0.

After the last significant position is signaled, the RRC proceeds with coding the coefficients subblock by subblock in the reverse diagonal scan order. At the start of each subblock, a subblock coded flag (sb_coded_flag) is signaled before any syntax elements for the coefficients themselves within that subblock. A subblock coded flag with value 0 indicates that all the coefficients within that subblock have the value zero, and so do not need to be signaled. Conversely, a subblock coded flag with value 1 indicates that there may be coefficients with non-zero values, so some further signaling is performed.

Because all coefficients after the last significant position must be zero valued, subblock coded flags for subblocks after the last significant position are not signaled. Their values, and the values of the transform coefficients contained in them, can be inferred as zero. The subblock containing the last significant position is guaranteed to contain at least one significant coefficient, so its subblock coded flag also does not need to be signaled and is automatically inferred to have a value of 1. The top-left subblock (e.g., subblock 1 702a in FIG. 7 and subblock 1 802a in FIG. 8 containing coefficient positions 0-15) is not guaranteed to contain significant coefficients but is highly likely to because it has the lowest frequency coefficients which are most likely to have large magnitude. The top-left subblock is also often referred to as the “DC subblock”. Then, by design the subblock coded flag corresponding to the DC subblock is also inferred to have a value of 1. All other subblock coded flags are signaled.

In the non-limiting example of FIG. 7, the subblock coded flags for the subblocks containing coefficient positions 80-95 (subblock 6 702f), 96-111 (subblock 7 702g) and 112-127 (subblock 8 702h) inclusive are inferred as zero because they are following the last significant position. The subblock coded flag for the subblock containing coefficient positions 64-79 (subblock 5 702e) is inferred as one because it contains the last significant position. Following this inference, the coefficients at positions 64-79 are signalled, starting at the last significant position 72 and progressing backward in the reverse scan order. Next, the subblock coded flag for the subblock containing coefficient positions 48-63 (subblock 4 702d) is signaled. If the subblock coded flag has the value 1, then the corresponding coefficients at positions 48-63 are signaled next. This is repeated for the subblocks containing coefficient positions 32-47 (subblock 3 702c) and 16-31 (subblock 2 702b) in that order (e.g., following the reverse scan order). Finally, the subblock coded flag for the subblock containing coefficient positions 0-15 is inferred as one, and the coefficients at positions 0-15 are signaled.

VVC utilises a context adaptive binary arithmetic coder (CABAC) (located in encoding module 320 and decoding module 402), which can adapt to and efficiently code a variety of syntax elements with different statistical properties. However, CABAC is computationally intensive compared to alternatives such as variable length binarization. For this reason, CABAC is not exclusively used to code syntax elements in VVC. In particular, the coding of residual coefficients occupies a significant portion of the total video bitstream. To ensure real-time encoders and decoders can maintain the throughput of CABAC coding, the extent of CABAC coding is limited for the heaviest burden on CABAC, which is coefficient coding. When encoding, transform coefficients are firstly binarized in a process described in detail below, with the individual bits after binarization referred to as “bins.” Each bin can then be coded either by the CABAC engine, in which case it is referred to as a “context coded bin,” or passed through to the bitstream as a bit, in which case it is referred to as a “bypass coded bin.” The maximum number of bins that are permitted to be context coded bins is referred to as the “CABAC bin budget” or “context coded bin budget” and is set at the residual block level to 1.75 bins per coefficient. For example, the 16×8 residual block of FIG. 7 has a CABAC bin budget of 1.75×16×8=224 bins. This limit applies only to syntax elements related to coefficient coding, which are described further below, and not to any other higher level syntax elements. The last significant position syntax elements and the subblock coded flags are not counted by the CABAC bin budget.

Each transform coefficient can be coded by a mixture of context and bypass coding, depending on the state of the CABAC bin budget and the magnitude of the coefficient itself. This is handled by several coding passes through the subblock, with each pass proceeding through the coefficients of the subblock in the reverse scan order already described above. That is, each coding pass begins at the last coefficient position and progresses backward through the numbered coefficient positions until terminated by some condition, or ending at the top-left most coefficient position in the subblock. For the subblock containing the last significant position, the last coefficient position is the last significant position, while for all other subblocks the last coefficient position is the bottom-right most coefficient position. The first two coding passes code the magnitude of the coefficients, while the third and final coding pass codes the sign of the coefficients.

The first coding pass binarizes and codes context coded syntax elements, and proceeds until either the CABAC bin budget is exhausted, or the pass reaches the end of the scan order. At each coefficient position, we first check whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements as described below. In the case where the first coding pass ends without terminating early (e.g., exhausting the CABAC bin budget) n is set to the value of the top-left coefficient position of the subblock minus one.

What context coded syntax elements are coded in the first coding pass depends at each coefficient on the magnitude of the coefficient. Firstly, a “significant coefficient flag” (sig_coeff_flag) may be signaled or inferred. This flag has a value of 0 when a current coefficient is zero in magnitude, and a value of 1 when the current coefficient is non-zero. Note that when a subblock coded flag has a value of 0, no further syntax elements are signaled for that subblock, and all sig_coeff_flag syntax elements corresponding to that subblock are inferred as 0. The sig_coeff_flag may be inferred as 1 for other edge cases. For example, at the last significant position the coefficient is already known to be significant and does not need to be signaled. Additionally, if a subblock coded flag has been signaled with a value of 1 but all significant coefficient flags within that subblock have a value of 0 until the final (e.g., the top-left most) significant coefficient flag for that subblock, that final significant coefficient flag must be inferred as 1. In all other cases, the significant coefficient flag is signalled.

If the significant coefficient flag is 0, then the coding pass proceeds to the next coefficient, as the current coefficient's value is already fully determined as zero. However, if the significant coefficient flag is 1, then next, a “greater than one flag” (gt1_flag) is signaled. This flag has a value of 1 when the current coefficient's magnitude is greater than one, and a value of 0 when the current coefficient's magnitude is one or less. If the greater than one flag is 0, then the coding pass proceeds to the next coefficient, as the current coefficient's magnitude is fully determined as one. If the greater than one flag is 1, then two more flags are signaled-a “parity flag”, and a “greater than three flag” (gt3_flag).

The parity flag has a value of 1 when the current coefficient's magnitude is odd, and has a value of 0 when the current coefficient's magnitude is even. The greater than three flag has a value of 1 when the current coefficient's magnitude is greater than three, and a value of 0 when the current coefficient's magnitude is three or less.

With each flag that is signaled, the remaining CABAC bin budget is decremented by one bin. Note that the remaining CABAC bin budget continues to be tracked and carries across the subblocks of the residual block. The number of context coded bins consumed by each coefficient is equal to the number of flags signaled, which depends on the coefficient's magnitude. However, the worst case is four bins, which is why the check at the beginning of each coefficient requires at least 4 bins in the remaining CABAC bin budget.

The second coding pass binarizes and codes with bypass coded bins the remaining portion of the transform coefficient magnitudes that have not already been coded in the first coding pass. The second coding pass is split into two parts. The first part is a pass over the coefficients from the last coefficient position of the subblock until before (not including) coefficient position n. The second part is a pass over the coefficients from position n to the top-left coefficient position in the subblock. The second coding pass can consist of just one of the parts. For example, if the first coding pass is completed without exhausting the CABAC bin budget, then the second coding pass will consist only of the first part. If the CABAC bin budget was already exhausted before the first coding pass began, then the second coding pass will consist only of the second part.

For each coefficient in the first part of the second coding pass, some part of the current coefficient's magnitude has already been signaled by the first coding pass. Therefore, in this case, a remainder may be signaled (abs_rem). No remainder needs to be signaled if the coefficient's magnitude can be fully determined from the context coded flags already signaled. As shown in Table 1, a remainder needs to be signaled when the greater than three flag has been signaled with a value of 1. Because the parity flag has already been signaled, the remaining part is always even in value. Therefore, abs_rem is signaled as a non-negative integer quantity, but then multiplied by two when added to reconstruct the coefficient's magnitude. abs_rem is binarized with a truncated Rice-Golomb binarization and bypass coded.

TABLE 1
Mapping between RRC coefficient syntax
elements and coefficient magnitude

| | | | | Coefficient |
|---|---|---|---|---|
| sig_coeff_flag | gt1_flag | parity_flag | gt3_flag | magnitude |
| 0 | — | — | — | 0 |
| 1 | 0 | — | — | 1 |
| 1 | 1 | 0 | 0 | 2 |
| 1 | 1 | 1 | 0 | 3 |
| 1 | 1 | 0 | 1 | 4 + 2*abs_rem |
| 1 | 1 | 1 | 1 | 5 + 2*abs_rem |
| — | — | — | — | dec_abs_level |

For each coefficient in the second part of the second coding pass, the first coding pass had already terminated, so all the current coefficient's magnitude (dec_abs_level) must be determined. dec_abs_level is not signaled and inferred as 0 for coefficients belonging to subblocks with a subblock coded flag of 0. Otherwise, it is binarized with a truncated Rice-Golomb binarization and bypass coded.

The third coding pass codes the sign bits associated with the transform coefficients. One sign bit is signaled for each non-zero transform coefficient—that is, for each coefficient with a significant coefficient flag with value 1. All the sign bits are bypass coded.

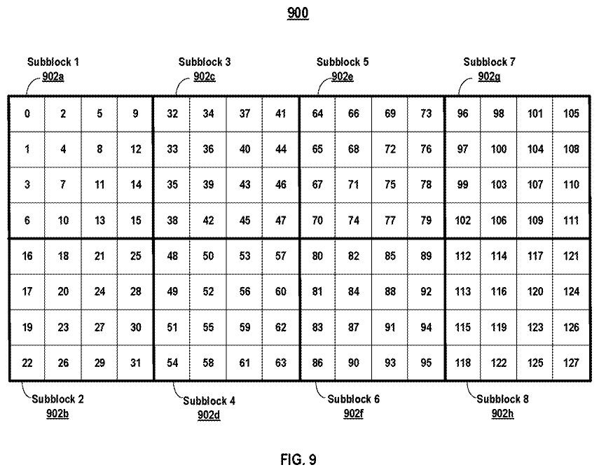

FIG. 9 illustrates a diagram of a TSRC scan order 900 with a 16×8 residual block, according to some embodiments of the present disclosure. The TSRC process is optimised for coding residual blocks that do have any transform applied. There are significant differences in the properties of the residual block, as compared to the residual block of RRC. Firstly, because there is no transform applied, there is no reason to expect the energy of the residual signal to be concentrated in the top-left coefficients, or for many coefficients in the bottom-right of the residual block to be quantised to zero. For this reason, the last significant position is not signaled in TSRC. Moreover, at least for intra predicted blocks, the prediction is made using neighbouring samples on the top-left edge of the coding block. On average, the top-left of the coding block may be predicted more accurately, resulting in smaller residual samples in the top-left of the block.

In TSRC, the residual coefficients are scanned with a hierarchical forward diagonal scan, which begins at the top-left of the block and ends at the bottom-right of the block. In the non-limiting example of FIG. 9, the hierarchical forward diagonal scan begins at position 0, then proceeds forwards through the numbered positions 1, 2, and so forth, ending at position 127.

Similar to RRC, for each 4×4 group of residual coefficients a subblock coding flag is determined. Unlike RRC, the subblock coding flag for the “DC subblock” is not inferred as 1. The last subblock coded flag (e.g., corresponding to subblock 8 902h) is inferred as 1 if all other subblock coded flags before the last subblock (e.g., subblock 8 902h) have a value of 0. Otherwise, the last subblock coded flag is also signaled.

In the example shown in FIG. 9, the subblock coded flag for the subblock containing coefficient positions 0-15 (subblock 1 902a) is signalled first. If the subblock coded flag has the value 1, then the corresponding coefficients at positions 0-15 are signalled. This is repeated for the subblocks containing coefficient positions 16-31 (subblock 2 902b), 32-47 (subblock 3 902c), 48-63 (subblock 4 902d), 64-79 (subblock 5 902e), 80-95 (subblock 6 902f), and 96-111 (subblock 7 902g) in that order (e.g., following the forward scan order). Finally, the subblock coded flag for the subblock containing coefficient positions 112-127 (subblock 8 902h) may be inferred as one if all other subblock coded flags have a value of 0, and is signalled otherwise. If the subblock coded flag has the value 1, the coefficients at positions 112-127 are signalled.

Like RRC, the TSRC process also codes the residual coefficients with a mixture of context and bypass coding. The amount of context coding allowed is controlled by the CABAC bin budget, which is calculated at the residual block level by the same method as for RRC. TSRC also sets the CABAC bin budget to 1.75 bins per coefficient. The coefficients are visited by several coding passes, with each pass proceeding through the coefficients of the subblock in the hierarchical forward scan order already described for TSRC. That is, each coding pass begins at the top-left most coefficient position in the subblock and progresses forwards through the numbered coefficient positions until terminated by some conditions, or ending at the bottom-right most coefficient position in the subblock. The first two coding passes code syntax elements using context coding, while the third and final coding pass uses bypass coding.

The first coding pass binarizes and codes context syntax elements, and proceeds until either the CABAC bin budget is exhausted, or the pass reaches the end of the scan order. At each coefficient position, we first check whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements as described below. In the case where the first coding pass ends without terminating early (e.g., exhausting the CABAC bin budget) n is set to N, where N is the value of the bottom-right coefficient position of the subblock plus one.

What context coded bins are coded in the first coding pass depends at each coefficient on the magnitude of the coefficient. Firstly, a “significant coefficient flag” (sig_coeff_flag) may be signaled. This flag has a value of 0 when a current coefficient is zero in magnitude, and a value of 1 when the current coefficient is non-zero. Note that when a subblock coded flag has a value of 0, no further syntax elements are signalled for that subblock, and all sig_coeff_flag syntax elements corresponding to that subblock are inferred as 0. The sig_coeff_flag may be inferred as 1 for other edge cases. For example, if a subblock coded flag has been set to 1 but all significant coefficient flags within that subblock have a value of 0 until the final (e.g., bottom-right most) significant coefficient flag for that subblock, that final significant coefficient flag must be inferred as 1. In all other cases, the significant coefficient flag is signalled.

If the significant coefficient flag is 0, then the coding pass proceeds to the next coefficient, as the current coefficient's value is already fully determined as zero. However, if the significant coefficient flag is 1, then two more flags are signaled-a “sign flag” (coeff_sign_flag) and a “greater than one flag” (gt1_flag). The sign flag indicates the sign of the coefficient. For instance, it has a value of 0 when the coefficient is positive, and a value of 1 when the coefficient is negative. The greater than one flag has a value of 1 when the current coefficient's magnitude is greater than one, and a value of 0 when the current coefficient's magnitude is one or less. If the greater than one flag is 0, then the coding pass proceeds to the next coefficient, as the current coefficient's magnitude is fully determined as one. If the greater than one flag is 1, then a parity flag is finally signaled, and the coding pass proceeds to the next coefficient. The parity flag has a value of 1 when the current coefficient's magnitude is odd, and has a value of 0 when the current coefficient's magnitude is even.

With each flag that is signaled, the remaining CABAC bin budget is decremented by one bin. Note that the remaining CABAC bin budget continues to be tracked and carries across the subblocks of the residual block. The number of context coded bins consumed by each coefficient is equal to the number of flags signaled, which depends on the coefficient's magnitude. However, the worst case is four bins, which is why the check at the beginning of each coefficient requires at least 4 bins in the remaining CABAC bin budget.

The second coding pass further codes the magnitude of the residual coefficients with context coded bins. As with the first coding pass, at each coefficient position, it is first checked whether the remaining CABAC bin budget is at least 4 bins. If it is less than 4 bins, then the second coding pass ends and the coefficient position where it has ended is recorded to a variable m. If the remaining CABAC bin budget is at least 4 bins, then the second coding pass can proceed by coding the coefficient at that position with syntax elements as described below. In the case where the first coding pass ends without terminating early (e.g., exhausting the CABAC bin budget) m is set to N.

What context coded bins are coded in the second coding pass depends on each coefficient on the magnitude of the coefficient. Firstly, if either the significant coefficient flag or the greater than one flag for the current coefficient were signaled as 0 in the first coding pass, then the current coefficient's magnitude is already fully determined, and no further syntax elements need to be signaled. Then, the coding pass proceeds to the next coefficient. Otherwise, up to four “greater than X” flags may be signaled, being “greater than three flag” (gt3_flag), “greater than five flag” (gt5_flag), “greater than seven flag” (gt7_flag), and “greater than nine flag” (gt9_flag) in signaling order. The gt3 flag is signaled first, and each subsequent greater than X flag is signaled if the prior greater than X flag has a value of 1. When any greater than X flag is signaled with a value of 0, or if the greater than nine flag is signaled, the coding pass proceeds to the next coefficient.

The third coding pass binarizes and codes with bypass coded bins the remaining portion of the residual coefficients that have not already been coded in the first two coding passes. The third coding pass is split into three parts. The first part is a pass over the coefficients from the first (top-left) coefficient until before (not including) coefficient position m. The second part is a pass over the coefficients from position m until before coefficient position n. The third part is a pass over the coefficients from position n to the last (bottom-right) coefficient position. Not all the parts occur in the third coding pass. For example, if the first two coding passes are completed without exhausting the CABAC bin budget, then m=n=N and the third coding pass will consist only of the first part. If the CABAC bin budget was exhausted in the second coding pass, then n=N and the third part of the third coding pass does not occur. If the CABAC bin budget was exhausted in the first coding pass, it will also be exhausted before the second coding pass can begin, so m will be the top-left most coefficient position, and the first part of the third coding pass does not occur.

A remainder is signaled when the current coefficient's value has not already been determined by signaled flags. As shown in Table 2, the coefficient can be fully determined if the sig_coeff_flag or any one of the greater than X flags has been signaled with a value of 0.

TABLE 2
Mapping between TSRC coefficient syntax elements and coefficient magnitude

| sig_coeff_flag | gt1_flag | gt3_flag | gt5_flag | gt7_flag | gt9_flag | Coefficient magnitude |
|---|---|---|---|---|---|---|
| 0 | — | — | — | — | — | 0 |
| 1 | 0 | — | — | — | — | 1 |
| 1 | 1 | — | — | — | — | 2 + parity_flag + 2*abs_rem |
| 1 | 1 | 0 | — | — | — | 2 + parity_flag |
| 1 | 1 | 1 | 0 | — | — | 4 + parity_flag |
| 1 | 1 | 1 | 1 | 0 | — | 6 + parity_flag |
| 1 | 1 | 1 | 1 | 1 | 0 | 8 + parity_flag |
| 1 | 1 | 1 | 1 | 1 | 1 | 10 + parity_flag + 2*abs_rem |
| — | — | — | — | — | — | abs_rem |

For each coefficient in the first part of the third coding pass, some part of the current coefficient's magnitude has been signaled by both the first and second coding passes. In this case a remainder (abs_rem) is signaled when the “greater than nine” flag (gt9_flag) has been signaled with a value of 1. Because the parity flag has already been signaled, the remaining part is always even in value. Therefore, abs_rem is signaled as a non-negative integer quantity, but then multiplied by two when added to reconstruct the coefficient's magnitude. The magnitude is determined as 10+parity_flag+2*abs_rem. abs_rem is binarized with a truncated Rice-Golomb binarization and bypass coded.

For each coefficient in the second part of the third coding pass, some part of the current coefficient's magnitude has been signaled by the first coding pass, but not by the second coding pass. In this case abs_rem is signaled when the greater than one flag has been signaled with a value of 1. Therefore, abs_rem is signaled as a non-negative integer quantity, but then multiplied by two when added to reconstruct the coefficient's magnitude. The magnitude is determined as 2+parity flag+2*abs_rem. abs_rem is binarized with a truncated Rice-Golomb binarization and bypass coded.

For each coefficient in the third part of the third coding pass, the first coding pass had already terminated, so all the current coefficient's value must be determined. abs_rem is not signaled and inferred as 0 for coefficients belonging to subblocks with a subblock coded flag of 0. Otherwise, it is binarized with a truncated Rice-Golomb binarization and bypass coded. If abs_rem is signaled, then the sign bit is signaled afterward as a bypass coded bin.

An RRC process has been proposed for ECM to replace the RRC process used in VVC. In the ECM RRC proposal, the syntax elements used to signal the transform coefficient magnitudes are modified. Higher level aspects of the RRC (e.g., the scan order, subblock coded flag signaling, last significant position signaling) have not been modified. Firstly, the number of greater than X flags is increased to F, where F=7. Secondly, the parity flag is moved in signaling order to after all the greater than X flags, and the parity flag is bypass coded. Because the parity is not known when the greater than X flags are signaled, the greater than X flags must increment by 1 at a time, rather than 2 at a time as in the RRC process of VVC.

In total, the context coded flags used to signal the transform coefficient magnitude are: significant coefficient flag, (sig_coeff_flag), greater than one flag (gt1_flag), greater than two flag, (gt2_flag), greater than three flag (gt3_flag), greater than four flag (gt4_flag), greater than five flag (gt5_flag), greater than six flag (gt6_flag), and greater than seven flag (gt7_flag).

At each coefficient position in the first coding pass, the new RRC still checks whether the remaining CABAC bin budget is at least 4 bins. If it is less than 4 bins, then the first coding pass ends and the coefficient position where it has ended is recorded to a variable n. If the remaining CABAC bin budget is at least 4 bins, then the first coding pass can proceed by coding the coefficient at that position with syntax elements corresponding to the first coding pass, such as significant coefficient flag, greater than X flags, and parity flag. In the case where the first coding pass ends without terminating early (e.g., exhausting the CABAC bin budget) n is set to the value of the top-left coefficient position minus one.

The significant coefficient flag may be signaled or inferred. This flag has a value of 0 when a current coefficient is zero in magnitude, and a value of 1 when the current coefficient is non-zero. When a subblock coded flag has a value of 0, no further syntax elements are signalled for that subblock, and all sig_coeff_flag syntax elements corresponding to that subblock are inferred as 0. The sig_coeff_flag may be inferred as 1 for other edge cases. For example, if a subblock coded flag has been signaled with a value of 1 but all significant coefficient flags within that subblock have a value of 0 until the final (e.g., the top-left most) significant coefficient flag for that subblock, that final significant coefficient flag must be inferred as 1. In all other cases the significant coefficient flag is signalled.

If the significant coefficient flag is 0, then the coding pass proceeds to the next coefficient, as the current coefficient's value is already fully determined as zero. Otherwise, up to seven “greater than X” flags may be signaled. The “greater than X” flags may include, e.g., “greater than one flag” (gt1_flag), “greater than two flag” (gt2_flag), “greater than three flag” (gt3_flag), “greater than four flag” (gt4_flag), “greater than five flag” (gt5_flag), “greater than six flag” (gt6_flag), and “greater than seven flag” (gt7_flag) in signalling order. The gt1_flag is signalled first, and each subsequent greater than X flag is signalled if the prior greater than X flag has a value of 1. When any greater than X flag is signalled with a value of 0, the coding pass proceeds to the next coefficient. Otherwise, if the greater than seven flag is signalled with a value of 1 (which means all the flags sig_coeff_flag, gt1_flag, . . . gt7_flag have the value 1), the parity flag is signalled as a bypass coded bin, and the coding pass proceeds to the next coefficient.

Each context coded flag that is signalled decrements the remaining CABAC bin budget by one bin. The number of context coded bins consumed by each coefficient is equal to the number of context coded flags signalled, which depends on the coefficient's magnitude. For the case F=7 and with the parity flag being bypass coded, the worst case is eight context coded bins, which means that the remaining CABAC bin budget could potentially reach a negative value (with the lowest value of −4).

Any remaining magnitude after coding the greater than X flags and the parity flag is still signaled with the bypass coded abs_rem syntax element, which is binarized with a truncated Rice-Golomb binarization and signaled in the second coding pass. If the CABAC bin budget was exhausted, then coefficients for which the full magnitude must be signaled, are still signaled with the bypass coded dec_abs_level syntax element.

The transform coefficient magnitude can be determined by the syntax elements as follows: sig_coeff_flag+gt1_flag+gt2_flag+gt3_flag+gt4_flag+gt5_flag+gt6_flag+gt7_flag+parity_flag+2*abs_rem, or equivalently, by the mapping shown in Table 3.

TABLE 3
Proposed mapping between RRC coefficient
syntax elements and coefficient magnitude

| | gt1 | gt2 | gt3 | gt4 | gt5 | gt6 | gt7 | Coefficient |
|---|---|---|---|---|---|---|---|---|
| sig_coeff flag | flag | flag | flag | flag | flag | flag | flag | magnitude |
| 0 | — | — | — | — | — | — | — | 0 |
| 1 | 0 | — | — | — | — | — | — | 1 |
| 1 | 1 | 0 | — | — | — | — | — | 2 |
| 1 | 1 | 1 | 0 | — | — | — | — | 3 |
| 1 | 1 | 1 | 1 | 0 | — | — | — | 4 |
| 1 | 1 | 1 | 1 | 1 | 0 | — | — | 5 |
| 1 | 1 | 1 | 1 | 1 | 1 | 0 | — | 6 |
| 1 | 1 | 1 | 1 | 1 | 1 | 1 | 0 | 7 |
| 1 | 1 | 1 | 1 | 1 | 1 | 1 | 1 | 8 + parity_flag + |
| | | | | | | | | 2*abs_rem |
| — | — | — | — | — | — | — | — | dec_abs_level |

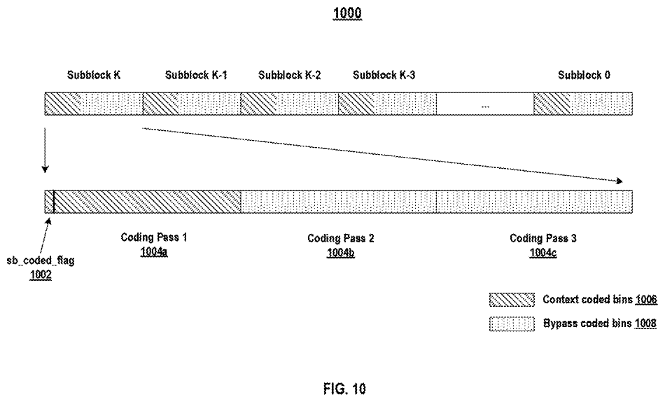

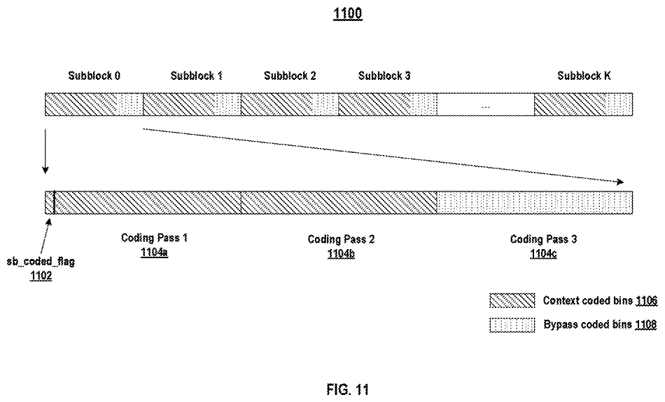

FIG. 10 illustrates an example bitstream order 1000 of coding context and bypass coded bins in an RRC process, according to some embodiments of the present disclosure. FIG. 11 illustrates an example bitstream order 1100 of coding context and bypass coded bins in a TSRC process, according to some embodiments of the present disclosure. FIGS. 10 and 11 will be described together.

Referring to FIGS. 10 and 11, both the RRC and TSRC processes are coded hierarchically by subblock first, and then progressing through the coding passes within each subblock. FIGS. 10 and 11 show the ordering of syntax elements within the bitstream for the RRC and TSRC processes, respectively, with shading showing the placement of context coded bins 1006, 1106 and bypass coded bins 1008, 1108. The subblocks are numbered by forward diagonal scan order, so subblock 0 corresponds to the top-left most subblock of the residual block, while subblock K corresponds to the bottom-right most subblock of the residual block.

Taking the example of FIG. 10, the RRC bitstream progresses over the subblocks in backward diagonal scan order, starting from subblock K and ending at subblock 0. Within each subblock, the bitstream may first begin with a context coded subblock coded flag (sb_coded_flag 1002) if its value is not inferred. Then, if the subblock coded flag has a value of 1, the rest of the subblock is composed of three coding passes, with the first coding pass 1004a containing context coded bins 1006 and the second coding pass 1004b and third coding pass 1004c containing bypass coded bins 1008.

Taking the example of FIG. 11, the TSRC bitstream progresses over the subblocks in forward diagonal scan order, starting from subblock 0 and ending at subblock K. Within each subblock, the bitstream may first begin with a context coded subblock coded flag (sb_coded_flag 1102) if its value is not inferred. Then, if the subblock coded flag has a value of 1, the rest of the subblock is composed of three coding passes. The first coding pass 1104a and second coding pass 1104b contain context coded bins 1106 and the third coding pass 1104c contains bypass coded bins 1108.

In both the RRC and TSRC bitstreams depicted in FIGS. 10 and 11, the CABAC engine (located at encoding module 320 and decoding module 402) must switch from context coding to bypass coding and then back to context coding for each subblock. The RRC and TSRC processes described above follow a hierarchical coding order that results in repeated switching between context and bypass coding per subblock. For implementations of the CABAC engine, excessive switching may be undesirable.

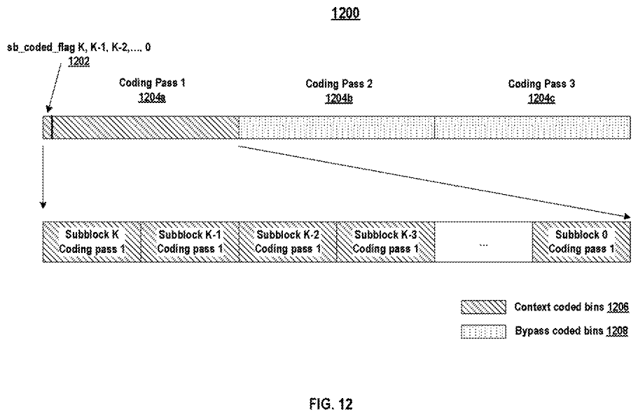

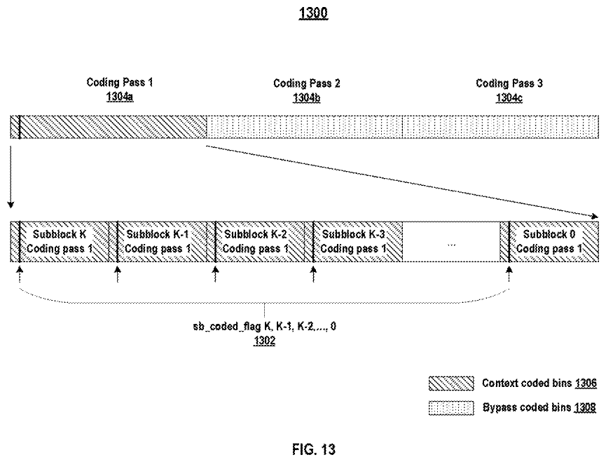

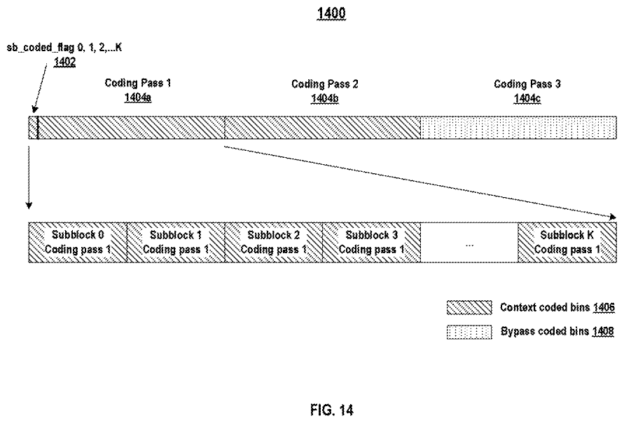

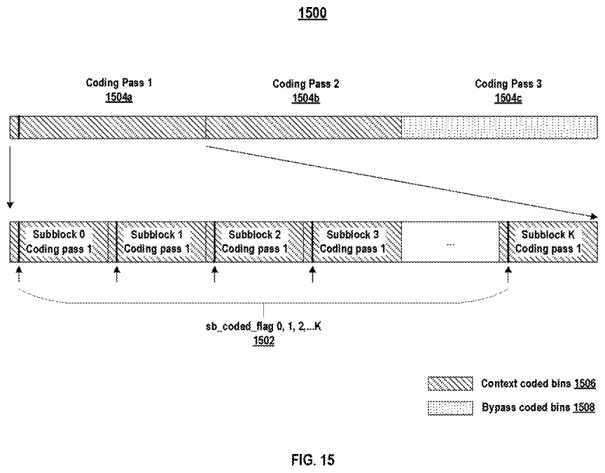

To overcome these and other challenges, the present disclosure provides an exemplary technique to code the syntax elements hierarchically by coding passes first, and then by subblocks. In some implementations, after the last significant coefficient position is signalled, all subblock coded flags are signalled together (as shown in FIGS. 12 and 14). In some other implementations, after the last significant coefficient position is signalled, the subblock coded flags are signalled at the start of each subblock (as shown in FIGS. 13 and 15). Additional details of the exemplary coding technique are provided below in connection with FIGS. 12-15.

FIG. 12 illustrates a first exemplary bitstream order 1200 of coding context and bypass coded bins in an RRC process, according to some embodiments of the present disclosure.

In one arrangement of this solution, referring to FIG. 12, the RRC process or the new RRC process is modified to code the syntax elements hierarchically by coding passes first, then by subblocks. After the last significant coefficient position is signalled, all subblock coded flags 1202 (sb_coded_flag K, sb_coded_flag K-1, sb_coded_flag K-2, . . . , 0) are signalled together. In the example of FIG. 12, all the subblock coded flags are enumerated, however it may be understood that some flags are not signalled in the bitstream if they are inferred.

Taking the example of FIG. 7, the subblock coded flags for the subblocks containing coefficient positions 80-95 (subblock 6 702f), 96-111 (subblock 7 702g), and 112-127 (subblock 8 702h) inclusive are inferred as zero because they are following the last significant position (e.g., 72 in the non-limiting example of FIG. 7). The subblock coded flag for the subblock containing coefficient positions 64-79 (subblock 5 702e) is inferred as one because it contains the last significant position. Following this inference, the subblock coded flags for subblocks containing coefficient positions 48-63 (subblock 4 702d), 32-47 (subblock 3 702c), and 16-31 (subblock 2 702b) are signalled in that order (e.g., following the reverse scan order). Finally, the subblock coded flag for the subblock containing coefficient positions 0-15 (subblock 1 702a) is inferred as one.

In FIG. 12, the first coding pass 1204a codes the context coded bins 1206, and the second coding pass 1204b and the third coding pass 1204c code the bypass coded syntax element bins 1208. Each coding pass is modified to progress through all the coefficients of the residual block in hierarchical reverse diagonal scan order before the next coding pass begins. In the first coding pass 1204a, if the first coding pass ends without terminating early (e.g., exhausting the CABAC bin budget), then n is instead set to the value of the top-left coefficient position of the residual block minus one. In other words, n is set to −1.

FIG. 12 depicts an example bitstream corresponding to this arrangement. By allowing each coding pass to progress through all the coefficients of the residual block before proceeding to the next coding pass, the context coded bins 1206 of RRC are grouped together and the bypass coded syntax element bins 1208 are grouped together. Therefore, the CABAC engine only switches from context coding to bypass coding once per residual block. In other words, the first coding pass 1204a is performed for the context coded bins 1206 in all subblocks K, K-1, K-2, . . . , 0. Then, the second coding pass 1204b and the third coding pass 1206c are similarly performed for all subblocks K, K-1, K-2, . . . , 0.

FIG. 13 illustrates a second exemplary bitstream order 1300 of coding context and bypass coded bins in an RRC process, according to some embodiments of the present disclosure.

In another arrangement, referring to FIG. 13, the RRC process or the new RRC process is modified to code the syntax elements hierarchically by coding passes first, then by subblocks. After the last significant coefficient position is signalled, the subblock coded flags 1302 (sb_coded_flag K, sb_coded_flag K-1, sb_coded_flag K-2, . . . , 0) are interleaved into the first coding pass 1304a. In the example of FIG. 13, all the subblock coded flags are enumerated, however it may be understood that some flags are not signalled in the bitstream if they are inferred.

Taking the example of FIG. 7, the subblock coded flags for the subblocks containing coefficient positions 80-95 (subblock 6 702f), 96-111 (subblock 7 702g), and 112-127 (subblock 8 702h) inclusive are inferred as zero because they are following the last significant position. The subblock coded flag 1302 for the subblock containing coefficient positions 64-79 (subblock 5 702e) is inferred as one because it contains the last significant position. Following this inference, syntax elements corresponding to coefficients at positions 64-79 (subblock 5 702e) for the first coding pass 1304a are signalled, starting at the last significant position 72 and progressing backward in the reverse scan order. Next, the subblock coded flag 1302 for the subblock containing coefficient positions 48-63 (subblock 4 702d) is signalled. If the subblock coded flag 1302 has the value 1, then syntax elements corresponding to coefficients at positions 48-63 (subblock 4 702d) for the first coding pass 1304a are signalled next. This is repeated for the subblocks containing coefficient positions 32-47 (subblock 3 702c) and 16-31 (subblock 2 702b) in that order (e.g., following the reverse scan order). Finally, the subblock coded flag 1302 for the subblock containing coefficient positions 0-15 (subblock 1 702a) is inferred as one, and syntax elements corresponding to coefficients at positions 0-15 (subblock 1 702a) for the first coding pass are signalled.

In FIG. 13, the first coding pass 1304a codes the context coded syntax element bins 1306, and the second coding pass 1304b and the third coding pass 1304c code the bypass coded syntax element bins 1308. If the first coding pass 1304a terminates early, then the remaining subblock coded flags are still signalled before proceeding to the second coding pass 1304b. If the first coding pass 1304a ends without terminating early (e.g., exhausting the CABAC bin budget), then n is instead set to the value of the top-left coefficient position of the residual block minus one. In other words, n is set to −1. The second coding pass 1304b and third coding pass 1304c are modified to progress through all the coefficients of the residual block in hierarchical reverse diagonal scan order before the next coding pass begins.

FIG. 13 depicts an example bitstream corresponding to this arrangement. While the subblock coded flags 1302 are interleaved into the first coding pass, the context coded syntax element bins 1306 and the bypass coded syntax element bins 1308 of RRC are still grouped together. This achieves the same benefit as the arrangement described with reference to FIG. 12.

FIG. 14 illustrates a first exemplary bitstream order 1400 of coding context and bypass coded bins in a TSRC process, according to some embodiments of the present disclosure.

In another arrangement, referring to FIG. 14, the TSRC process is modified to code the syntax elements hierarchically by coding passes first, then by subblocks. The subblock coded flags 1402 (sb_coded_flag 0, sb_coded_flag 1, sb_coded_flag 2, . . . , K) are signalled together before the first coding pass 1404a begins. In the example of FIG. 14, all the subblock coded flags are enumerated, however it may be understood that some flags are not signalled in the bitstream if they are inferred.

Taking the example of FIG. 9, the subblock coded flags 1402 for the subblocks containing coefficient positions 0-15 (subblock 1 902a), 16-31 (subblock 2 902b), 32-47 (subblock 3 902c), 48-63 (subblock 4 902d), 64-79 (subblock 5 902e), 80-95 (subblock 6 902f), and 96-111 (subblock 7 902g) are signalled in that order (e.g., following the forward scan order). Finally, the subblock coded flag 1402 for the subblock containing coefficient positions 112-127 (subblock 8 902h) may be inferred as one if all other subblock coded flags 1402 have a value of 0, and is signalled otherwise.

In FIG. 14, the first coding pass 1404a and the second coding pass 1404b code the context coded syntax element bins 1406, and the third coding pass 1404c codes the bypass coded bins 1408. Each coding pass is modified to progress through all the coefficients of the residual block in hierarchical forward diagonal scan order before the next coding pass begins. In the first coding pass, if the first coding pass 1404a ends without terminating early (e.g., exhausting the CABAC bin budget), then n is set to N, where N is instead the value of the bottom-right coefficient position of the residual block plus one. Equivalently, N is the number of coefficients in the residual block. If the second coding pass 1404b ends without terminating early, then m is set to N.

FIG. 14 depicts an example bitstream corresponding to this arrangement. By allowing each coding pass to progress through all the coefficients of the residual block, the context coded syntax element bins 1406 of TSRC are grouped together and the bypass coded bins 1408 of TSRC are grouped together. Therefore, the CABAC engine only switches from context coding to bypass coding once per residual block.

FIG. 15 illustrates a second exemplary bitstream order 1500 of coding context and bypass coded bins in an RRC process, according to some embodiments of the present disclosure.

In another arrangement, referring to FIG. 15, the TSRC process is modified to code the syntax elements hierarchically by coding passes first, then by subblocks. The subblock coded flags 1502 (sb_coded_flag 0, sb_coded_flag 1, sb_coded_flag 2, . . . , K) are interleaved into the first coding pass. In the example of FIG. 15, all the subblock coded flags are enumerated, however it may be understood that some flags are not signalled in the bitstream if they are inferred.

Taking the example of FIG. 9, the subblock coded flag 1502 for the subblock containing coefficient positions 0-15 (subblock 1 902a) is signalled. If the subblock coded flag 1502 has the value 1, then syntax elements corresponding to coefficients at positions 0-15 (subblock 1 902a) for the first coding pass 1504a are signalled next. This is repeated for the subblocks containing coefficient positions 16-31 (subblock 2 902b), 32-47 (subblock 3 902c), 48-63 (subblock 4 902d), 64-79 (subblock 5 902e), 80-95 (subblock 6 902f), and 96-111 (subblock 7 902g) in that order (e.g., following the forward scan order). Finally, the subblock coded flag 1502 for the subblock containing coefficient positions 112-127 (subblock 8 902h) may be inferred as one if all other subblock coded flags 1502 have a value of 0, and is signalled otherwise. If the subblock coded flag 1502 has the value 1, syntax elements corresponding to coefficients at positions 112-127 (subblock 8 902h) for the first coding pass 1504a are signalled.

In FIG. 15, the first coding pass 1504a and the second coding pass 1504b code the context coded syntax element bins 1506, and the third coding pass 1504c codes the bypass coded syntax element bins 1508. If the first coding pass first coding pass 1504a terminates early, then the remaining subblock coded flags 1502 are still signalled before proceeding to the second coding pass 1504b. If the first coding pass 1504a ends without terminating early (e.g., exhausting the CABAC bin budget), then n is set to N, where N is instead the value of the bottom-right coefficient position of the residual block plus one. Equivalently, N is the number of coefficients in the residual block. If the second coding pass 1504b ends without terminating early, then m is set to N. The second coding pass 1504b and third coding pass 1504c are modified to progress through all the coefficients of the residual block in hierarchical reverse diagonal scan order before the next coding pass begins.

FIG. 15 depicts an example bitstream corresponding to this arrangement. While the subblock coded flags 1502 are interleaved into the first coding pass 1504a, the context coded syntax element bins 1506 of TSRC are still grouped together. This achieves the same benefit as the arrangement described with reference to FIG. 14.

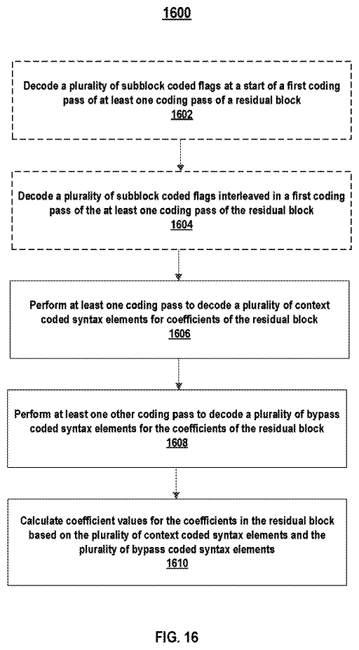

FIG. 16 illustrates a flowchart of a first exemplary method 1600 of video decoding, according to some embodiments of the present disclosure. Method 1600 may be performed by a system, e.g., such as decoding system 200, decoder 201, or decoding module 402 (e.g., with a CABAC engine, bypass coding engine, etc.), just to name a few. Method 1600 may include operations 1602-1610, as described below. It is to be appreciated that some of the steps may be optional, and some of the steps may be performed simultaneously, or in a different order than shown in FIG. 16.

Referring to FIG. 16, at 1602, the system may decode a plurality of subblock coded flags at a start of a first coding pass of at least one coding pass of a residual block. For example, referring to FIGS. 4, 12, and 14, decoding module 402 may decode a plurality of subblock coded flags 1202 or 1402 (sb_coded_flags) at the start of the first coding pass of the residual block.

At 1604, the system may decode a plurality of subblock coded flags interleaved in a first coding pass of the at least one coding pass of the residual block. In some implementations, each subblock coded flag may be decoded directly before decoding context coded syntax elements corresponding to coefficients of a respective subblock. For example, referring to FIGS. 4 and 13, decoding module 402 may, after the last significant coefficient position is signalled, decode the subblock coded flags 1302 (sb_coded_flag K, sb_coded_flag K-1, sb_coded_flag K-2, . . . , 0), which are interleaved into the first coding pass 1304a. In another example, referring to FIGS. 4 and 15, decoding module 402 may decode the subblock coded flags 1502 (sb_coded_flag 0, sb_coded_flag 1, sb_coded_flag 2, . . . , K), which are interleaved into the first coding pass 1504a.

At 1606, the system may perform at least one coding pass to decode a plurality of context coded syntax elements for coefficients of the residual block. In some implementations, the at least one coding pass may include a first coding pass. For example, referring to FIGS. 4 and 12-15, decoding module 402 may perform a first coding pass 1204a, 1304a, 1404a or 1504a to decode a plurality of context coded syntax elements (bins 1206, 1306, 1406 or 1506) for coefficients of the residual block. In other implementations, the at least one coding pass may include a first coding pass and a second coding pass. For example, referring to FIGS. 4 and 14-15, decoding module 402 may perform a second coding pass 1404b or 1504b to decode another plurality of context coded syntax elements (context coded syntax element bins 1406 or 1506). In some implementations, decoding module 402 may decode a plurality of subblock coded flags 1302 or 1502 (sb_coded_flags) interleaved in the first coding pass, such that each subblock coded flag is decoded directly before syntax elements corresponding to coefficients belonging to that subblock.

At 1608, after the plurality of context coded syntax elements are decoded for coefficients of the residual block, the system may perform at least one other coding pass to decode a plurality of bypass coded syntax elements for coefficients of the residual block. In some implementations, the at least one other coding pass may include both a second coding pass and a third coding pass, and the first coding pass, the second coding pass, and the third coding pass are part of an RRC process. For example, referring to FIGS. 4 and 12-13, decoding module 402 may perform a second coding pass 1204b or 1304b and a third coding pass 1204c or 1304c to decode a plurality of bypass coded syntax elements (bins 1208 or 1308) for coefficients of the residual block. In such case, in the second coding pass the decoding module 402 decodes bypass coded abs_rem or dec_abs syntax elements from the bitstream. In the third coding pass the decoding module 402 decodes bypass coded sign bits for all the non-zero coefficients of the residual block.

In other implementations of 1608, the at least one other coding pass may include a third coding pass, and the first coding pass, the second coding pass, and the third coding pass are part of a TSRC process. For example, referring to FIGS. 4 and 14-15, decoding module 402 may perform a third coding pass 1404c or 1504c to decode a plurality of bypass coded syntax elements (bins 1408 or 1508) for coefficients of the residual block. In such case, in the third coding pass, the decoding module 402 decodes bypass coded abs_rem or dec_abs syntax elements from the bitstream.

At 1610, the system may calculate coefficient values for coefficients in the residual block based on the plurality of context coded syntax elements and the plurality of bypass coded syntax elements. Referring to FIG. 4, decoding module 402 may calculate the coefficient values for coefficients in the residual block based on the context coded syntax elements (bins 1206, 1306, 1406, 1506) and the bypass coded syntax elements (bins 1208, 1308, 1408, 1508). The coefficient values may be calculated from these syntax elements as described above with reference to Table 1 or Table 3 for the RRC process or may be calculated as described above with reference to Table 2 for the TSRC process.

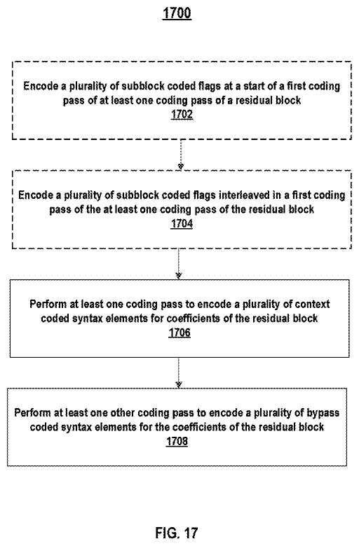

FIG. 17 illustrates a flowchart of an exemplary method 1700 of video encoding, according to some embodiments of the present disclosure. Method 1700 may be performed by a system, e.g., such as encoding system 100, encoder 101, or encoding module 320 (e.g., CABAC engine, bypass coding engine, etc.), just to name a few. Method 1700 may include operations 1702-1708, as described below. It is to be appreciated that some of the steps may be optional, and some of the steps may be performed simultaneously, or in a different order than shown in FIG. 17.

Referring to FIG. 17, at 1702, the system may encode a plurality of subblock coded flags at a start of a first coding pass of at least one coding pass of a residual block. For example, referring to FIGS. 3, 12, and 14, encoding module 320 may encode a plurality of subblock coded flags 1202 or 1402 (sb_coded_flags) at the start of the first coding pass of the residual block.

At 1704, the system may encode a plurality of subblock coded flags interleaved in a first coding pass of the at least one coding pass of the residual block. In some implementations, each subblock coded flag may be encoded directly before encoding context coded syntax elements corresponding to coefficients of a respective subblock. For example, referring to FIGS. 3 and 13, encoding module 320 may, after the last significant coefficient position is signalled, encode the subblock coded flags 1302 (sb_coded_flag K, sb_coded_flag K-1, sb_coded_flag K-2, . . . , 0), which are interleaved into the first coding pass 1304a. In another example, referring to FIGS. 3 and 15, encoding module 320 may encode the subblock coded flags 1502 (sb_coded_flag 0, sb_coded_flag 1, sb_coded_flag 2, . . . , K), which are interleaved into the first coding pass 1504a.

At 1706, the system may perform at least one coding pass to encode a plurality of context coded syntax elements for coefficients of the residual block. In some implementations, the at least one coding pass may include a first coding pass. For example, referring to FIGS. 3 and 12-15, encoding module 320 may perform a first coding pass 1204a, 1304a, 1404a or 1504a to encode a plurality of context coded syntax elements (bins 1206, 1306, 1406 or 1506) for coefficients of the residual block. In other implementations, the at least one coding pass may include a first coding pass and a second coding pass. For example, referring to FIGS. 3 and 14-15, encoding module 320 may perform a second coding pass 1404b or 1504b to encode another plurality of context coded syntax elements (context coded syntax element bins 1406 or 1506). In some implementations, encoding module 320 may encode a plurality of subblock coded flags 1302 or 1502 (sb_coded_flags) interleaved in the first coding pass, such that each subblock coded flag is encoded directly before syntax elements corresponding to coefficients belonging to that subblock.

At 1708, after the plurality of context coded syntax elements are encoded for coefficients of the residual block, the system may perform at least one other coding pass to encode a plurality of bypass coded syntax elements for coefficients of the residual block. In some implementations, the at least one other coding pass may include both a second coding pass and a third coding pass, and the first coding pass, the second coding pass, and the third coding pass are part of an RRC process. For example, referring to FIGS. 3 and 12-13, encoding module 320 may perform a second coding pass 1204b or 1304b and a third coding pass 1204c or 1304c to encode a plurality of bypass coded syntax elements (bins 1208 or 1308) for coefficients of the residual block. In such case, in the second coding pass the encoding module 320 encodes bypass coded abs_rem or dec_abs syntax elements to the bitstream. In the third coding pass the encoding module 320 encodes bypass coded sign bits for all the non-zero coefficients of the residual block.

In other implementations of 1708, the at least one other coding pass may include a third coding pass, and the first coding pass, the second coding pass, and the third coding pass are part of a TSRC process. For example, referring to FIGS. 3 and 14-15, encoding module 320 may perform a third coding pass 1404c or 1504c to encode a plurality of bypass coded syntax elements (bins 1408 or 1508) for coefficients of the residual block. In such case, in the third coding pass the encoding module 320 encodes bypass coded abs_rem or dec_abs syntax elements to the bitstream.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, include CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of decoding by a decoder is provided. The method may include performing by a processor, at least one coding pass to decode a plurality of context coded syntax elements for coefficients of a residual block. The method may include performing, by the processor, at least one other coding pass to decode a plurality of bypass coded syntax elements for coefficients of the residual block. The method may include calculating, by the processor, coefficient values for coefficients of the residual block based on the plurality of context coded syntax elements and the plurality of bypass coded syntax elements.

In some implementations, the at least one coding pass may include a first coding pass. In some implementations, the at least one other coding pass may include a second coding pass and a third coding pass. In some implementations, the first coding pass, the second coding pass, and the third coding pass may be part of an RRC process.

In some implementations, performing the at least one other coding pass to decode the plurality of bypass coded syntax elements for coefficients of the residual block may include performing, by the processor, the second coding pass to decode a first subset of the plurality of bypass coded syntax elements for coefficients of the residual block. In some implementations, performing the at least one other coding pass to decode the plurality of bypass coded syntax elements for coefficients of the residual block may include performing, by the processor, the third coding pass to decode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, performing, by the processor, the at least one coding pass to decode the plurality of context coded syntax elements for coefficients of the residual block may include performing, by the processor, the first coding pass to decode a first subset of the plurality of context coded syntax elements for coefficients of the residual block. In some implementations, performing, by the processor, the at least one coding pass to decode the plurality of context coded syntax elements for coefficients of the residual block may include performing, by the processor, the second coding pass to decode a second subset of the plurality of context coded syntax elements for coefficients of the residual block.

In some implementations, the method may include decoding, by the processor, a plurality of subblock coded flags at a start of a first coding pass of the at least one coding pass of the residual block.

In some implementations, the method may include decoding, by the processor, a plurality of subblock coded flags interleaved in a first coding pass of the at least one coding pass of the residual block. In some implementations, each subblock coded flag may be decoded directly before decoding context coded syntax elements corresponding to coefficients of a respective subblock.

According to another aspect of the present disclosure, a decoder is provided. The decoder may include a processor and memory storing instructions. The memory storing instructions, which when executed by the processor, may cause the processor to perform at least one coding pass to decode a plurality of context coded syntax elements for coefficients of a residual block. The memory storing instructions, which when executed by the processor, may cause the processor to perform at least one other coding pass to decode a plurality of bypass coded syntax elements for coefficients of the residual block. The memory storing instructions, which when executed by the processor, may cause the processor to calculate coefficient values for coefficients of the residual block based on the plurality of context coded syntax elements and the plurality of bypass coded syntax elements.

In some implementations, the at least one coding pass may include a first coding pass. In some implementations, the at least one other coding pass may include a second coding pass and a third coding pass. In some implementations, the first coding pass, the second coding pass, and the third coding pass are part of an RRC process.

In some implementations, to perform the at least one other coding pass to decode the plurality of bypass coded syntax elements for coefficients of the residual block, the memory storing instructions, which when executed by the processor, may cause the processor to perform the second coding pass to decode a first subset of the plurality of bypass coded syntax elements for coefficients of the residual block. In some implementations, to perform the at least one other coding pass to decode the plurality of bypass coded syntax elements for coefficients of the residual block, the memory storing instructions, which when executed by the processor, may cause the processor to perform the third coding pass to decode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, to perform the at least one coding pass to decode the plurality of context coded syntax elements for coefficients of the residual block, the memory storing instructions, which when executed by the processor, may cause the processor to perform the first coding pass to decode a first subset of the plurality of context coded syntax elements for coefficients of the residual block. In some implementations, to perform the at least one coding pass to decode the plurality of context coded syntax elements for coefficients of the residual block, the memory storing instructions, which when executed by the processor, may cause the processor to perform the second coding pass to decode a second subset of the plurality of context coded syntax elements for coefficients of the residual block.

In some implementations, the memory storing instructions, which when executed by the processor, may cause the processor to decode a plurality of subblock coded flags at a start of a first coding pass of the at least one coding pass of the residual block.

In some implementations, the memory storing instructions, which when executed by the processor, may cause the processor to decode a plurality of subblock coded flags interleaved in a first coding pass of the at least one coding pass of the residual block. In some implementations, each subblock coded flag may be decoded directly before decoding context coded syntax elements corresponding to coefficients of a respective subblock.

According to a further aspect of the present disclosure, an apparatus for decoding is provided. The apparatus for decoding may include a processor and memory storing instructions. The memory storing instructions, which when executed by the processor, may cause the processor to perform at least one coding pass to decode a plurality of context coded syntax elements for coefficients of a residual block. The memory storing instructions, which when executed by the processor, may cause the processor to perform at least one other coding pass to decode a plurality of bypass coded syntax elements for coefficients of the residual block. The memory storing instructions, which when executed by the processor, may cause the processor to calculate coefficient values for coefficients of the residual block based on the plurality of context coded syntax elements and the plurality of bypass coded syntax elements.

According to another aspect of the present disclosure, a non-transitory computer-readable medium is provided. The non-transitory computer-readable medium may instructions, which when executed by a processor of a decoder, may cause the processor of the decoder to perform at least one coding pass to decode a plurality of context coded syntax elements for coefficients of a residual block. The instructions, which when executed by the processor of the decoder, may cause the processor of the decoder to perform at least one other coding pass to decode a plurality of bypass coded syntax elements for coefficients of the residual block. The instructions, which when executed by the processor of the decoder, may cause the processor of the decoder to calculate coefficient values for coefficients of the residual block based on the plurality of context coded syntax elements and the plurality of bypass coded syntax elements.

In some implementations, the at least one coding pass may include a first coding pass. In some implementations, the at least one other coding pass may include a second coding pass and a third coding pass. In some implementations, the first coding pass, the second coding pass, and the third coding pass are part of an RRC process.

In some implementations, to perform the at least one other coding pass to decode the plurality of bypass coded syntax elements for coefficients of the residual block, the instructions, which when executed by the processor of the decoder, may cause the processor of the decoder to perform the second coding pass to decode a first subset of the plurality of bypass coded syntax elements for coefficients of the residual block. In some implementations, to perform the at least one other coding pass to decode the plurality of bypass coded syntax elements for coefficients of the residual block, the instructions, which when executed by the processor of the decoder, may cause the processor of the decoder to perform the third coding pass to decode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, to perform the at least one coding pass to decode the plurality of context coded syntax elements for coefficients of the residual block, the instructions, which when executed by the processor of the decoder, may cause the processor of the decoder to perform the first coding pass to decode a first subset of the plurality of context coded syntax elements for coefficients of the residual block. In some implementations, to perform the at least one coding pass to decode the plurality of context coded syntax elements for coefficients of the residual block, the instructions, which when executed by the processor of the decoder, may cause the processor of the decoder to perform the second coding pass to decode a second subset of the plurality of context coded syntax elements for coefficients of the residual block.

In some implementations, the instructions, which when executed by the processor of the decoder, may cause the processor of the decoder to decode a plurality of subblock coded flags at a start of a first coding pass of the at least one coding pass of the residual block.

In some implementations, the instructions, which when executed by the processor of the decoder, may cause the processor of the decoder to decode a plurality of subblock coded flags interleaved in a first coding pass of the at least one coding pass of the residual block. In some implementations, each subblock coded flag may be decoded directly before decoding context coded syntax elements corresponding to coefficients of a respective subblock.

According to one aspect of the present disclosure, a method of encoding by a encoder is provided. The method may include performing by a processor, at least one coding pass to encode a plurality of context coded syntax elements for coefficients of a residual block. The method may include performing, by the processor, at least one other coding pass to encode a plurality of bypass coded syntax elements for coefficients of the residual block.

In some implementations, the at least one coding pass may include a first coding pass. In some implementations, the at least one other coding pass may include a second coding pass and a third coding pass. In some implementations, the first coding pass, the second coding pass, and the third coding pass may be part of an RRC process.

In some implementations, performing the at least one other coding pass to encode the plurality of bypass coded syntax elements for coefficients of the residual block may include performing, by the processor, the second coding pass to encode a first subset of the plurality of bypass coded syntax elements for coefficients of the residual block. In some implementations, performing the at least one other coding pass to encode the plurality of bypass coded syntax elements for coefficients of the residual block may include performing, by the processor, the third coding pass to encode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, performing, by the processor, the at least one coding pass to encode the plurality of context coded syntax elements for coefficients of the residual block may include performing, by the processor, the first coding pass to encode a first subset of the plurality of context coded syntax elements for coefficients of the residual block. In some implementations, performing, by the processor, the at least one coding pass to encode the plurality of context coded syntax elements for coefficients of the residual block may include performing, by the processor, the second coding pass to encode a second subset of the plurality of context coded syntax elements for coefficients of the residual block.

In some implementations, the method may include encoding, by the processor, a plurality of subblock coded flags at a start of a first coding pass of the at least one coding pass of the residual block.

In some implementations, the method may include encoding, by the processor, a plurality of subblock coded flags interleaved in a first coding pass of the at least one coding pass of the residual block. In some implementations, each subblock coded flag may be encoded directly before encoding context coded syntax elements corresponding to coefficients of a respective subblock.

According to another aspect of the present disclosure, a encoder is provided. The encoder may include a processor and memory storing instructions. The memory storing instructions, which when executed by the processor, may cause the processor to perform at least one coding pass to encode a plurality of context coded syntax elements for coefficients of a residual block. The memory storing instructions, which when executed by the processor, may cause the processor to perform at least one other coding pass to encode a plurality of bypass coded syntax elements for coefficients of the residual block.

In some implementations, the at least one coding pass may include a first coding pass. In some implementations, the at least one other coding pass may include a second coding pass and a third coding pass. In some implementations, the first coding pass, the second coding pass, and the third coding pass are part of an RRC process.

In some implementations, to perform the at least one other coding pass to encode the plurality of bypass coded syntax elements for coefficients of the residual block, the memory storing instructions, which when executed by the processor, may cause the processor to perform the second coding pass to encode a first subset of the plurality of bypass coded syntax elements for coefficients of the residual block. In some implementations, to perform the at least one other coding pass to encode the plurality of bypass coded syntax elements for coefficients of the residual block, the memory storing instructions, which when executed by the processor, may cause the processor to perform the third coding pass to encode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, to perform the at least one coding pass to encode the plurality of context coded syntax elements for coefficients of the residual block, the memory storing instructions, which when executed by the processor, may cause the processor to perform the first coding pass to encode a first subset of the plurality of context coded syntax elements for coefficients of the residual block. In some implementations, to perform the at least one coding pass to encode the plurality of context coded syntax elements for coefficients of the residual block, the memory storing instructions, which when executed by the processor, may cause the processor to perform the second coding pass to encode a second subset of the plurality of context coded syntax elements for coefficients of the residual block.

In some implementations, the memory storing instructions, which when executed by the processor, may cause the processor to encode a plurality of subblock coded flags at a start of a first coding pass of the at least one coding pass of the residual block.

In some implementations, the memory storing instructions, which when executed by the processor, may cause the processor to encode a plurality of subblock coded flags interleaved in a first coding pass of the at least one coding pass of the residual block. In some implementations, each subblock coded flag may be encoded directly before encoding context coded syntax elements corresponding to coefficients of a respective subblock.

According to a further aspect of the present disclosure, an apparatus for encoding is provided. The apparatus for encoding may include a processor and memory storing instructions. The memory storing instructions, which when executed by the processor, may cause the processor to perform at least one coding pass to encode a plurality of context coded syntax elements for coefficients of a residual block. The memory storing instructions, which when executed by the processor, may cause the processor to perform at least one other coding pass to encode a plurality of bypass coded syntax elements for coefficients of the residual block.

According to another aspect of the present disclosure, a non-transitory computer-readable medium is provided. The non-transitory computer-readable medium may instructions, which when executed by a processor of a encoder, may cause the processor of the encoder to perform at least one coding pass to encode a plurality of context coded syntax elements for coefficients of a residual block. The instructions, which when executed by the processor of the encoder, may cause the processor of the encoder to perform at least one other coding pass to encode a plurality of bypass coded syntax elements for coefficients of the residual block.

In some implementations, the at least one coding pass may include a first coding pass. In some implementations, the at least one other coding pass may include a second coding pass and a third coding pass. In some implementations, the first coding pass, the second coding pass, and the third coding pass are part of an RRC process.

In some implementations, to perform the at least one other coding pass to encode the plurality of bypass coded syntax elements for coefficients of the residual block, the instructions, which when executed by the processor of the encoder, may cause the processor of the encoder to perform the second coding pass to encode a first subset of the plurality of bypass coded syntax elements for coefficients of the residual block. In some implementations, to perform the at least one other coding pass to encode the plurality of bypass coded syntax elements for coefficients of the residual block, the instructions, which when executed by the processor of the encoder, may cause the processor of the encoder to perform the third coding pass to encode a second subset of the plurality of bypass coded syntax elements for all non-zero coefficients of the residual block.

In some implementations, the at least one coding pass may include a first coding pass and a second coding pass. In some implementations, the at least one other coding pass may include a third coding pass. In some implementations, the first coding pass, the second coding pass, and the third coding pass are part of a TSRC process.

In some implementations, to perform the at least one coding pass to encode the plurality of context coded syntax elements for coefficients of the residual block, the instructions, which when executed by the processor of the encoder, may cause the processor of the encoder to perform the first coding pass to encode a first subset of the plurality of context coded syntax elements for coefficients of the residual block. In some implementations, to perform the at least one coding pass to encode the plurality of context coded syntax elements for coefficients of the residual block, the instructions, which when executed by the processor of the encoder, may cause the processor of the encoder to perform the second coding pass to encode a second subset of the plurality of context coded syntax elements for coefficients of the residual block.

In some implementations, the instructions, which when executed by the processor of the encoder, may cause the processor of the encoder to encode a plurality of subblock coded flags at a start of a first coding pass of the at least one coding pass of the residual block.

In some implementations, the instructions, which when executed by the processor of the encoder, may cause the processor of the encoder to encode a plurality of subblock coded flags interleaved in a first coding pass of the at least one coding pass of the residual block. In some implementations, each subblock coded flag may be encoded directly before encoding context coded syntax elements corresponding to coefficients of a respective subblock.

According to still another aspect of the present disclosure, a non-transitory computer-readable medium storing a bitstream is provided. The bitstream may be generated according to one or more of the operations described herein.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of decoding by a decoder, comprising:
performing by a processor, at least one coding pass to decode a plurality of context coded syntax elements for coefficients of a residual block;
performing, by the processor, at least one other coding pass to decode a plurality of bypass coded syntax elements for coefficients of the residual block; and
calculating, by the processor, coefficient values for coefficients of the residual block based on the plurality of context coded syntax elements and the plurality of bypass coded syntax elements.

2. The method of claim 1, wherein:
the at least one coding pass includes a first coding pass,
the at least one other coding pass includes a second coding pass and a third coding pass, and
the first coding pass, the second coding pass, and the third coding pass are part of a regular residual coding (RRC) process.

3. The method of claim 2, wherein performing the at least one other coding pass to decode the plurality of bypass coded syntax elements for coefficients of the residual block comprises:
performing, by the processor, the second coding pass to decode a first subset of the plurality of bypass coded syntax elements for coefficients of the residual block; and
performing, by the processor, the third coding pass to decode a second subset of the plurality of bypass coded syntax elements for all non-zero coefficients of the residual block.

4. The method of claim 1, wherein:
the at least one coding pass includes a first coding pass and a second coding pass,
the at least one other coding pass includes a third coding pass, and
the first coding pass, the second coding pass, and the third coding pass are part of a transform skip residual coding (TSRC) process.

5. The method of claim 4, wherein performing, by the processor, the at least one coding pass to decode the plurality of context coded syntax elements for coefficients of the residual block comprises:
performing, by the processor, the first coding pass to decode a first subset of the plurality of context coded syntax elements for coefficients of the residual block; and
performing, by the processor, the second coding pass to decode a second subset of the plurality of context coded syntax elements for coefficients of the residual block.

6. The method of claim 1, further comprising:
decoding, by the processor, a plurality of subblock coded flags at a start of a first coding pass of the at least one coding pass of the residual block.

7. The method of claim 1, further comprising:
decoding, by the processor, a plurality of subblock coded flags interleaved in a first coding pass of the at least one coding pass of the residual block, wherein each subblock coded flag is decoded directly before decoding context coded syntax elements corresponding to coefficients of a respective subblock.

8. A method of encoding by an encoder, comprising:
performing by a processor, at least one coding pass to encode a plurality of context coded syntax elements for coefficients of a residual block; and
performing, by the processor, at least one other coding pass to encode a plurality of bypass coded syntax elements for coefficients of the residual block.

9. The method of claim 8, wherein:
the at least one coding pass includes a first coding pass,
the at least one other coding pass includes a second coding pass and a third coding pass, and
the first coding pass, the second coding pass, and the third coding pass are part of a regular residual coding (RRC) process.

10. The method of claim 9, wherein performing the at least one other coding pass to encode the plurality of bypass coded syntax elements for coefficients of the residual block comprises:
performing, by the processor, the second coding pass to encode a first subset of the plurality of bypass coded syntax elements for coefficients of the residual block; and
performing, by the processor, the third coding pass to encode a second subset of the plurality of bypass coded syntax elements for all non-zero coefficients of the residual block.

11. The method of claim 8, wherein:
the at least one coding pass includes a first coding pass and a second coding pass,
the at least one other coding pass includes a third coding pass, and
the first coding pass, the second coding pass, and the third coding pass are part of a transform skip residual coding (TSRC) process.

12. The method of claim 11, wherein performing, by the processor, the at least one coding pass to encode the plurality of context coded syntax elements for coefficients of the residual block comprises:
performing, by the processor, the first coding pass to encode a first subset of the plurality of context coded syntax elements for coefficients of the residual block; and
performing, by the processor, the second coding pass to encode a second subset of the plurality of context coded syntax elements for coefficients of the residual block.

13. The method of claim 8, further comprising:
encoding, by the processor, a plurality of subblock coded flags at a start of a first coding pass of the at least one coding pass of the residual block.

14. The method of claim 8, further comprising:
encoding, by the processor, a plurality of subblock coded flags interleaved in a first coding pass of the at least one coding pass of the residual block, wherein each subblock coded flag is encoded directly before encoding context coded syntax elements corresponding to coefficients of a respective subblock.

15. A non-transitory computer-readable medium storing computer programs/instructions and a bitstream, wherein the computer programs/instructions are executed by a processor to perform an encoding method to generate the bitstream, and the encoding method comprises:
performing at least one coding pass to encode a plurality of context coded syntax elements for coefficients of a residual block; and
performing at least one other coding pass to encode a plurality of bypass coded syntax elements for coefficients of the residual block.

16. The non-transitory computer-readable medium of claim 15, wherein:
the at least one coding pass includes a first coding pass,
the at least one other coding pass includes a second coding pass and a third coding pass, and
the first coding pass, the second coding pass, and the third coding pass are part of a regular residual coding (RRC) process.

17. The non-transitory computer-readable medium of claim 16, wherein, to perform the at least one other coding pass to encode the plurality of bypass coded syntax elements for coefficients of the residual block, the instructions, which when executed by the processor, cause the processor to:
perform the second coding pass to encode a first subset of the plurality of bypass coded syntax elements for coefficients of the residual block; and
perform the third coding pass to encode a second subset of the plurality of bypass coded syntax elements for all non-zero coefficients of the residual block.

18. The non-transitory computer-readable medium of claim 15, wherein:
the at least one coding pass includes a first coding pass and a second coding pass,
the at least one other coding pass includes a third coding pass, and
the first coding pass, the second coding pass, and the third coding pass are part of a transform skip residual coding (TSRC) process.

19. The non-transitory computer-readable medium of claim 18, wherein, to perform the at least one coding pass to encode the plurality of context coded syntax elements for coefficients of the residual block, the instructions, which when executed by the processor, cause the processor to:
perform the first coding pass to encode a first subset of the plurality of context coded syntax elements for coefficients of the residual block; and
perform the second coding pass to encode a second subset of the plurality of context coded syntax elements for coefficients of the residual block.

20. The non-transitory computer-readable medium of claim 15, wherein the instructions, which when executed by the processor, cause the processor to:
encode a plurality of subblock coded flags at a start of a first coding pass of the at least one coding pass of the residual block.
